(19) United States
(12) Patent Application Publication
(10) Pub. No.: US 2012/0259698 A1
(43) Pub. Date: Oct. 11, 2012

(54) Electronic Currency Management System

(76) Inventor: A. Pierre Yurow, Rockville, MD (US)

(21) Appl. No.: 13/443,308

(22) Filed: Apr. 10, 2012

Related U.S. Application Data
(63) Continuation-in-part of application No. 13/441,917, filed on Apr. 9, 2012.
(60) Provisional application No. 61/473,844, filed on Apr. 11, 2011.
(60) Provisional application No. 61/473,952, filed on Apr. 11, 2011.

(51) Int. Cl. G06Q 20/36; G06Q 40/02; G06Q 30/02

(52) U.S. Cl. 705/14.51; 705/41; 705/38

(57) ABSTRACT

A computer implemented method and system for managing electronic currency of a consumer is provided. A mobile wallet application on a consumer device of the consumer and a transaction management server, in communication with the mobile wallet application via a network, are provided. The mobile wallet application receives and stores incentives obtained by the consumer for engaging in one or more commercial activities. The mobile wallet application converts the incentives to electronic currency and stores the electronic currency in the mobile wallet application. The mobile wallet application, in communication with the transaction management server via the network generates one or more electronic monetary objects using the electronic currency. The generated electronic monetary objects are, for example, cash, airtime credit, etc. The mobile wallet application, in communication with the transaction management server via the network, conducts one or more transactions using the electronic currency or the generated electronic monetary objects.

### CROSS REFERENCE TO RELATED APPLICATIONS

This application is a continuation-in-part application of non-provisional patent application Ser. No. 13/441,917 titled “Management Of Advertisements, Electronic Commerce, And Consumer Services” filed on Apr. 9, 2012 in the United States Patent and Trademark Office, which claims the benefit of provisional patent application No. 61/473,844 filed on Apr. 11, 2011 in the United States Patent and Trademark Office. This application also claims the benefit of provisional patent application No. 61/473,952 filed on Apr. 11, 2011 in the United States Patent and Trademark Office.

The specifications of the above referenced patent applications are incorporated herein by reference in their entirety.

### BACKGROUND

Targeted advertising refers to a class of advertising services for product and service companies that targets consumers with relevant advertisements. Several mechanisms have been employed for targeting advertisements to consumers. However, existing systems lack an integrated management of advertisements and related consumer services, thereby either making the consumers lose interest in participating in the targeted advertisement service, or failing to provide related and value-added services to keep the consumers engaged.

Electronic commerce refers to financial and retail transactions over electronic systems such as computer networks and cellular networks. Existing systems do not provide methods to effectively integrate targeted advertising with value-added electronic commerce services for the benefit of consumers.

Commercial entities are increasingly providing consumer-beneficial electronic commerce and consumer services and incentives to consumers as a marketing strategy in order to promote their products and/or services. The consumer-beneficial electronic commerce and consumer services and incentives are often distributed to the consumers in the form of coupons, tickets, or electronically, for example, in the form of redeemable points. Often, the electronic incentives are provided on a card, which the customers need to carry with them for use in a store. Each commercial entity issues unique cards that are only redeemable at a store of that particular commercial entity, thereby resulting in a multiplicity of cards that is often inconvenient to manage and carry around. Moreover, most cards can only be used to avail discounts on products and/or services purchased within the same commercial entity, thereby limiting the consumer's ability to use the electronic incentives. Furthermore, existing systems do not allow the consumer to use the electronic incentives to conduct transactions that would be useful to the consumer, for example, for availing micro-loans, conversion of the electronic incentives to cash, etc.

Hence, there is a long felt but unresolved need for a computer implemented method and system that manages advertisements, electronic commerce, and consumer services and integrates targeted advertising with consumer-beneficial electronic commerce, consumer services and incentives that make the consumer opt-in for an advertisement communication service and keep the consumer engaged with the advertisement communication service. Furthermore, there is a long felt but unresolved need for a computer implemented method and system that converts incentives to electronic currency that allows the consumer to perform different types of financial transactions that are relevant and useful to the consumer and that avoids use of multiple cards to avail the incentives.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for managing advertisements, electronic commerce, and consumer services and for integrating targeted advertising with consumer-beneficial electronic commerce, consumer services and incentives such as subsidized mobile services to make a consumer opt-in for an advertisement communication service, to retain the interest of the consumer for the advertisement communication service, and to keep the consumer engaged with the advertisement communication service.

An advertisement management platform comprising at least one processor configured to manage an advertisement distribution service for consumers is provided. As used herein, the term “advertisement distribution service” refers to a service provided by the advertisement management platform for acquiring advertisement media from retailers, advertisers, and marketing and branding entities, performing targeted distribution of the advertisements to consumers, integrating targeted advertising with consumer-beneficial electronic commerce, consumer services and incentives to retain the interest of the consumers, etc. In an embodiment, an electronic commerce management server configured to communicate with the advertisement management platform, is provided. The electronic commerce management server comprises at least one processor configured to manage the electronic commerce and consumer services.

The advertisement management platform registers one or more consumers with the advertisement distribution service by creating a consumer profile for each of those consumers. The consumer profile comprises dynamic behavioral data of each of the registered consumers. The advertisement management platform targets advertisements to the registered consumers based on the dynamic behavioral data of the registered consumers through one or more of multiple media and communication channels. The media and communication channels comprise, for example, fixed cellular networks, mobile cellular networks, an unstructured supplementary service data channel, wireless application protocol (WAP) browsers, mobile web browsers, short message services, multimedia messaging services, internet web portals, digital television, etc. The advertisement management platform engages the registered consumers with the targeted advertisements based on an advertisement engagement plan of the advertisement distribution service. The advertisement engagement plan requires each of the registered consumers to consume and provide a response to a predetermined number of targeted advertisements within a predetermined time period. The advertisement management platform provides the registered consumers with one or more incentives, for example, coupons, vouchers, electronic currency, etc., when the response to one or more of the predetermined number of targeted advertisements confirms consumption of the targeted advertisements.

An electronic mobile wallet application executable by at least one processor is provided to each of the registered consumers for electronically storing the incentives, for example, as coupons, vouchers, and/or electronic currency. The mobile wallet application is accessible through a wide spectrum of technologies and devices, for example, a general packet radio service (GPRS), 3G, a short message service (SMS) or multimedia messaging service (MMS) message communication, a voice over internet protocol (VOIP) voice or data communication, or other internet enabled cellular phones and tablet computing devices, computers with connection to the internet, televisions with digital set top boxes, etc. The mobile wallet application is accessible on a consumer device, for example, a personal computer, a laptop, a mobile phone such as the iPhone® of Apple Inc., a personal digital assistant, a tablet computing device such as the iPad® of Apple Inc., a global system for mobile communications (GSM) device or a code division multiple access (CDMA) communication device that utilizes unstructured supplementary service data (USSD) or a wireless application protocol (WAP) browser or a mobile web browser for communicating with the advertisement management platform, a television with a digital set top box, a game console such as the PlayStation® of Sony Corporation, the Xbox® of Microsoft Corporation, the Nintendo® Wii®, other communication devices, etc. The mobile wallet application is also accessible through a web browser, for example, a wireless application protocol (WAP) browser or a mobile web browser on the consumer device via a network, for example, the internet, an intranet, a local area network (LAN), a wide area network (WAN), a communication network that implements Wi-Fi® of the Wireless Ethernet Compatibility Alliance, Inc., a cellular network, a mobile communication network, etc.

The mobile wallet application enables exchange of the incentives, for example, the coupons and the electronic currency for retail transactions using the electronic commerce management server or a transaction management server. In an embodiment, the advertisement management platform engages the registered consumers, for example, with transaction of the coupons based on an incentive engagement plan of the advertisement distribution service. The incentive engagement plan requires each of the registered consumers to accept and redeem a predetermined number of incentives, for example, coupons within a predetermined time period. The advertisement management platform maintains the dynamic behavioral data of each of the registered consumers in a central data warehouse. The dynamic behavioral data is regularly updated in the data warehouse for each engagement of the registered consumers with the targeted advertisements and each exchange of the incentives, for example, the coupons and the electronic currency for retail transactions.

The computer implemented method and system disclosed herein provides web voice, mobile data, mobile wallet and mobile messaging services, wherein one or more of these services are fully or substantially subsidized through a loyalty program and/or with a mobile operator service plan. The service plan comprises, for example, advertising to consumers using both visual and audio content through targeted advertising engagements referred to as cost per engagement (CPE); coupon or voucher distribution referred to as cost per acquisition (CPA); coupon or voucher redemption at retail locations referred to as cost per purchase (CPP); and a targeted survey or a poll referred to as cost per survey (CPS). The computer implemented method and system disclosed herein may deliver targeted advertising over multiple media and communication channels comprising, for example, fixed and mobile voice networks, an unstructured supplementary service data (USSD) channel, wireless application protocol (WAP) browsers, mobile web browsers, a short message service (SMS), a multimedia messaging service (MMS), the internet, digital televisions, automated teller machine (ATM) screens and other multimedia, where available.

The mobile wallet application enables redemption of the incentives, for example, the coupons for retail transactions at a point of sale, the redemption of electronic cash for physical cash at a point of sale, and redemption of the incentives for the purchasing of airtime credit for mobile phone services at a point of sale. The information on one or more of the incentives, for example, the coupons, the vouchers and/or the electronic cash stored by the mobile wallet application is captured at a point of sale system in response to a request to redeem the stored coupons, vouchers and/or electronic cash by the registered consumers. The point of sale system transmits the captured information to the advertisement management platform, in real time, for validating the stored coupons, vouchers and/or electronic cash and enabling redemption of the stored coupons, vouchers and/or electronic cash for the retail transactions. The electronic commerce management server or the transaction management server removes the stored coupons, vouchers and/or electronic cash from the mobile wallet application after the redemption of the stored coupons, vouchers and/or electronic cash at the point of sale. The electronic commerce management server or the transaction management server tracks the exchange of the coupons and the electronic currency for the retail transactions and stores the tracked information in the data warehouse. In an embodiment, the mobile wallet application converts the electronic currency received as one or more of the incentives to equivalent airtime credit for mobile phone services and vice versa. In another embodiment, the mobile wallet application converts the electronic currency to physical currency and vice versa.

The electronic commerce management server and/or the transaction management server in conjunction with the mobile wallet application provides support for additional electronic commerce services comprising loyalty programs and retail transactions. The data warehouse proactively generates consumer analytics information, for example, based on the consumer profile of each of the registered consumers, information on advertisement engagements and coupon engagements of the registered consumers, and the tracked information of the exchange of the coupons and electronic currency by the registered consumers for retail transactions. The advertisement management platform selectively provides the generated consumer analytics information, for example, to one or more retailers, advertisers, and marketing and branding service providers to allow the retailers, the advertisers, and the marketing and branding service providers to develop advertisement campaigns based on the consumer analytics information. In an embodiment, the data warehouse implements predictive analytics for predictively determining the results of the advertisement campaigns and for predicting system utilization for advertising, coupon transmissions, and coupon redemptions for each of the advertisement campaigns.

Furthermore, the computer implemented method and system disclosed herein addresses the above stated need for converting incentives to electronic currency that allows a consumer to perform different types of financial transactions that are relevant and useful to the consumer and that avoids use of multiple cards to avail the incentives. The computer implemented method and system disclosed herein manages the electronic currency of the consumer. The mobile wallet application executable by at least one processor is provided on a consumer device of the consumer. A transaction management server, in communication with the mobile wallet application via a network, is provided. The transaction management server comprises at least one processor configured to manage the electronic currency of the consumer. The mobile wallet application receives and stores incentives obtained by the consumer for engaging in one or more commercial activities. As used herein, the term “commercial activities” refers to activities performed by the consumer, which provide monetary benefit to the consumer. The commercial activities engaged by the consumer comprise, for example, one or more of purchasing a product and/or a service, responding to a targeted advertisement, completing a survey, completing a poll, opting in for a loyalty program, submitting a review, etc.

The mobile wallet application converts the incentives to electronic currency and stores the electronic currency in the mobile wallet application. The mobile wallet application, in communication with the transaction management server via the network, generates one or more electronic monetary objects using the electronic currency. The generated electronic monetary objects comprise, for example, one or more of cash, airtime credit, etc. The mobile wallet application, in communication with the transaction management server via the network, then conducts one or more transactions using the electronic currency or the generated electronic monetary objects.

In an embodiment, the conduction of the transactions comprises transferring the electronic currency from the mobile wallet application of a first consumer to a second consumer. The mobile wallet application of the first consumer acquires transaction information from the first consumer, for example, via a graphical user interface (GUI) of the mobile wallet application. The transaction information comprises, for example, identification information of the second consumer, an amount of the electronic currency to be transferred to the second consumer, etc. The mobile wallet application of the first consumer transmits the acquired transaction information to the transaction management server via the network. The transaction management server decrements the specified amount of electronic currency from the mobile wallet application of the first consumer and transmits the specified amount of electronic currency to the mobile wallet application of the second consumer via the network. The mobile wallet application of the second consumer receives the transmitted amount of electronic currency and redeems the received amount of electronic currency for conducting one or more transactions.

In an embodiment, the conduction of the transactions comprises transferring the generated electronic monetary objects from the mobile wallet application of the first consumer to the second consumer. For example, the mobile wallet application, in communication with the transaction management server via the network, generates an electronic monetary object, for example, airtime credit using the electronic currency. The mobile wallet application of the first consumer acquires transaction information from the first consumer via a GUI of the mobile wallet application. The transaction information comprises, for example, identification information of the second consumer, an amount of airtime credit to be transferred to the second consumer. The mobile wallet application of the first consumer transmits the acquired transaction information to the transaction management server via the network. The transaction management server decrements the amount of airtime credit from the mobile wallet application of the first consumer and transmits the amount of airtime credit to the mobile wallet application of the second consumer via the network. The mobile wallet application of the second consumer receives the transmitted amount of airtime credit and redeems the received amount of the airtime credit for mobile communication services. In an embodiment, the mobile wallet application of the second customer converts the received amount of airtime credit, for example, to equivalent cash for conducting one or more transactions.

In an embodiment, the conduction of the transactions comprises engaging in a loan transaction with one or more second consumers by a first consumer via the mobile wallet application using the electronic currency configured as a micro-loan. In an embodiment, the mobile wallet application, in communication with the transaction management server via the network, generates micro-loans using the electronic currency. The mobile wallet application of the first consumer receives a request for one or more of the generated micro-loans from a second consumer via the transaction management server over the network. The mobile wallet application of the first consumer, via the transaction management server over the network, transmits the generated micro-loans to the mobile wallet application of the second consumer after the first consumer approves the request. The transaction management server decrements the generated micro-loans from the mobile wallet application of the first consumer via the network.

In another embodiment, the mobile wallet application of the first consumer transmits a request for a micro-loan to a predetermined number of second consumers via the transaction management server over the network. On approval of the request by the second consumers, the mobile wallet application of the first consumer receives the micro-loan from the predetermined number of second consumers via the transaction management server over the network. In an embodiment, the transaction management server defines a predetermined number of sponsor consumers required by the first consumer for sponsoring a debt of the micro-loan for the first consumer. The sponsor consumers are the consumers registered with the transaction management server who agree to sponsor the debt of the micro-loan for the first consumer. The mobile wallet application of the first consumer transmits a sponsor request to the predetermined number of the sponsor consumers via the transaction management server over the network. The mobile wallet application of the first consumer receives the micro-loan from the predetermined number of second consumers on acceptance of the sponsor request by the predetermined number of sponsor consumers who agree to sponsor the debt of the micro-loan for the first consumer. The mobile wallet application of the first consumer stores the micro-loan as electronic currency in the mobile wallet application for conducting one or more transactions.

In an embodiment, the transaction management server tracks information on the transactions and stores the tracked information in a data warehouse. In an embodiment, one or more of multiple advertising entities target advertisements to the consumer on receiving an indication from the transaction management server, during the conduction of the transactions by the mobile wallet application. In an embodiment, the transaction management server generates a transaction code for each of the transactions and transmits the generated transaction code to the mobile wallet application on the consumer device of the consumer via the network.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented method for managing advertisements, electronic commerce, and consumer services.

FIG. 2 illustrates a computer implemented system for managing advertisements, electronic commerce, and consumer services.

FIG. 3 exemplarily illustrates a flowchart comprising the steps for providing and utilizing an advertisement distribution service of the advertisement management platform.

FIG. 4A exemplarily illustrates a flowchart of back end communication between the advertisement management platform and a point of sale for coupon or voucher redemptions.

FIG. 4B exemplarily illustrates a flowchart of a front end transaction at a point of sale for redeeming coupons or vouchers according to the computer implemented method and system disclosed herein.

FIG. 4C exemplarily illustrates a flowchart of a transaction at a point of sale having a radio frequency (RF) reader for redeeming coupons or vouchers.

FIG. 4D exemplarily illustrates a flowchart of a transaction at a point of sale that uses unstructured supplementary service data (USSD), a wireless application protocol (WAP) browser, a mobile web browser session or other similar real time sessions for validating a coupon or a voucher.

FIG. 5 exemplarily illustrates an embodiment of the advertisement distribution service, advertisement engagement, and coupon engagement of the advertisement management platform in association with a managed service organization (MSO).

FIG. 6A exemplarily illustrates a use case describing consumer registration for the advertisement distribution service provided by the advertisement management platform through a managed service organization (MSO) set top box on a television screen.

FIG. 6B exemplarily illustrates a use case describing consumer registration for the advertisement distribution service provided by the advertisement management platform through a managed service organization (MSO) using a web portal or a call center.

FIG. 6C exemplarily illustrates a use case describing a scenario where a consumer is targeted by the advertisement management platform to engage in an advertisement campaign dialog through television menus for acquiring coupons or vouchers.

FIG. 6D exemplarily illustrates a use case describing a scenario where a consumer is targeted by the advertisement management platform to engage in an advertisement campaign dialog on a television screen for acquiring coupons or vouchers.

FIG. 6E exemplarily illustrates a use case describing a scenario where a consumer is targeted by the advertisement management platform to engage in an advertisement campaign dialog on a mobile wallet application deployed on a mobile consumer device or a web browser for acquiring coupons or vouchers.

FIG. 6F exemplarily illustrates a use case describing a scenario where a consumer redeems a coupon or voucher at a retail point of sale using the mobile wallet application.

FIG. 7 illustrates a computer implemented method for managing electronic currency of a consumer.

FIG. 8 exemplarily illustrates a first embodiment of the computer implemented method for managing electronic currency of consumers.

FIG. 9 exemplarily illustrates a second embodiment of the computer implemented method for managing electronic currency of consumers.

FIG. 10 exemplarily illustrates a third embodiment of the computer implemented method for managing electronic currency of consumers.

FIG. 11 exemplarily illustrates a fourth embodiment of the computer implemented method for managing electronic currency of a consumer.

FIG. 12 exemplarily illustrates a computer implemented system for managing electronic currency of a consumer.

FIG. 13 exemplarily illustrates the architecture of a computer system employed by an advertisement management platform, an electronic commerce management server, a transaction management server, and/or a consumer device for managing advertisements, electronic commerce, electronic currency, and consumer services.

FIG. 14 exemplarily illustrates a flow chart depicting the flow of electronic currency into multiple transactions according to the computer implemented method and system disclosed herein.

FIG. 15 exemplarily illustrates a flow chart comprising the steps for a peer-to-peer cash remittance of electronic currency using the mobile wallet application according to the computer implemented method and system disclosed herein.

FIGS. 16A-16B exemplarily illustrate a flow chart comprising the steps for a peer-to-peer airtime remittance using the mobile wallet application according to the computer implemented method and system disclosed herein.

FIGS. 17A-17B exemplarily illustrate a flow chart comprising the steps for a micro-loan transaction according to the computer implemented method and system disclosed herein.

### DETAILED DESCRIPTION OF THE INVENTION

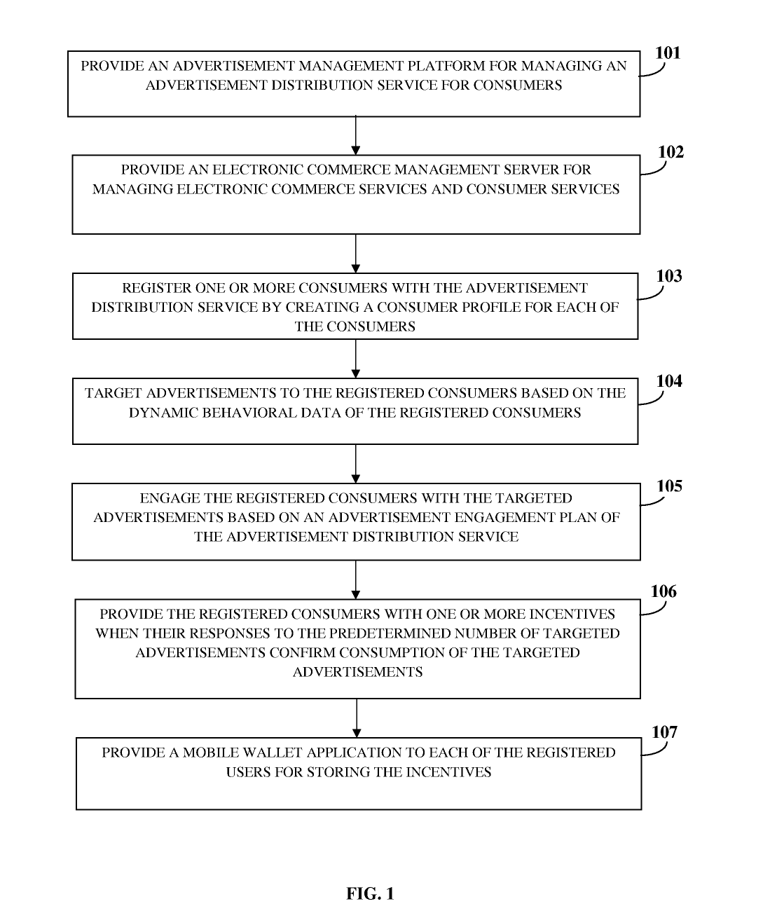

FIG. 1 illustrates a computer implemented method for managing advertisements, electronic commerce, and consumer services. An advertisement management platform comprising at least one processor configured to manage an advertisement distribution service for multiple consumers is provided 101. As used herein, the term “advertisement distribution service” refers to a service provided by the advertisement management platform for acquiring advertisement media from retailers, advertisers, and marketing and branding entities, performing targeted distribution of the advertisements to consumers, integrating targeted advertising with consumer-beneficial electronic commerce and consumer services and incentives to retain the interest of the consumers, etc. In an embodiment, an electronic commerce management server configured to communicate with the advertisement management platform, is provided 102. The electronic commerce management server comprises at least one processor configured to manage electronic commerce services and consumer services, for example, subsidized mobile services. The advertisement management platform registers 103 one or more consumers with the advertisement distribution service by creating a consumer profile for each of those consumers. The consumer profile comprises dynamic behavioral data of each of the registered consumers. For example, the dynamic behavioral data of each of the registered consumers comprises psychographic and demographic data provided during registration or sign up for the advertisement distribution service, and data generated from every advertisement engagement of the registered consumer and every voucher or coupon engagement of the registered consumer. Prior to initiation of the advertisement distribution service, the consumers may be required to answer an array of demographic and psychographic profiling questions before their services commence. This survey, along with accumulated and synthesized behavioral data is used to target specific advertisements and offers to the targeted consumers on an individual basis.

The advertisement management platform targets 104 advertisements to the registered consumers based on the dynamic behavioral data of the registered consumers through one or more of multiple media and communication channels. Targeted advertising is delivered over multiple media and communication channels comprising, for example, fixed and mobile voice networks, an unstructured supplementary service data (USSD) channel, wireless application protocol (WAP) or mobile web browsers, short message services (SMS), multimedia messaging services (MMS), the internet, internet web portals, digital television, automated teller machine (ATM) screens and other multimedia, where available. The advertisement management platform engages 105 the registered consumers with the targeted advertisements based on an advertisement engagement plan of the advertisement distribution service. As used herein, each “advertisement engagement” refers to the requirement of the consumer to respond to the advertisement after consumption such that the response indicates or confirms the consumption of the advertisement. The advertisement engagement plan requires each of the registered consumers to consume and provide a response to a predetermined number of targeted advertisements within a predetermined time period. For example, as part of the advertisement engagement plan, the consumers are required to engage with a certain number of advertisements per day. The advertisement management platform provides 106 the registered consumers with one or more incentives, for example, coupons, vouchers, electronic currency, etc., when their responses to one or more of the predetermined number of targeted advertisements confirm consumption of the targeted advertisements.

In an embodiment, an electronic mobile wallet application executable by at least one processor is provided 107 to each of the registered consumers for electronically storing the incentives, also herein referred to as coupons and/or electronic currency. The mobile wallet application is accessible through a wide spectrum of technologies and devices, for example, a general packet radio service (GPRS), 3G, a short message service (SMS) or multimedia messaging service (MMS) message communication, a voice over internet protocol (VOIP) voice or data communication, or other internet enabled cellular phones and tablet computing devices, computers with connection to the internet, televisions with digital set top boxes, etc. The mobile wallet application is accessible on a consumer device, for example, a personal computer, a laptop, a mobile phone such as the iPhone® of Apple Inc., a personal digital assistant, a tablet computing device such as the iPad® of Apple Inc., a global system for mobile communications (GSM) or a code division multiple access (CDMA) communication device that utilizes an unstructured supplementary service data (USSD) or a wireless application protocol (WAP) browser, or a mobile web browser for communicating with the advertisement management platform, a television with a digital set top box, a game console such as the PlayStation® of Sony Corporation, the Xbox® of Microsoft Corporation, the Nintendo® Wii®, other communication devices, etc. The USSD protocol enables the consumer to perform fast data and low cost browsing on the GSM or CDMA communication device. The mobile wallet application is also accessible, for example, through a web browser, for example, a WAP browser or a mobile web browser on the consumer device via a network, for example, the internet, an intranet, a local area network (LAN), a wide area network (WAN), a communication network that implements Wi-Fi® of the Wireless Ethernet Compatibility Alliance, Inc., a cellular network, a mobile communication network, a mobile wireless network, etc. The consumer may access and engage with the advertisements via the WAP browser or the mobile web browser of the GSM or CDMA communication device. The mobile wallet application enables exchange of the coupons and the electronic currency for retail transactions using the electronic commerce management server or a transaction management server as disclosed in the detailed description of FIG. 7.

In an embodiment, each targeted advertisement has a unique question or query that is appended to the end of the targeted advertisement copy. The targeted advertisement requires the consumer to engage with the advertisement, which, for example, could be a forced engagement that may not be bypassed by the consumer. Every advertisement is individually targeted based on the individual consumer profiles. Each voucher or coupon offer may also be individually targeted based on the individual consumer profiles. The advertisement management platform updates each consumer profile by capturing behavioral data, for example, psychographic and demographic data during the service registration or sign up, from every previous advertisement engagement of the consumer, and from every previous voucher or coupon engagement of the consumer. The data on every advertisement and voucher or coupon campaign is tracked for the advertisers down to individual consumer profiles. The advertisements, coupons, and vouchers are delivered over different communication networks and media channels comprising, for example, mobile networks, the internet, television, and other media.

The mobile wallet application enables redemption of the incentives, for example, the coupons stored in the mobile wallet application for retail transactions at a point of sale, redemption of electronic cash for physical cash at a point of sale, and redemption of the incentives, for example, the coupons, electronic currency, etc., for purchasing airtime credit for mobile phone services at a point of sale. The information on one or more of the incentives, for example, the coupons, such as a coupon number or an offer code stored by the mobile wallet application is captured at a point of sale system in response to a request to redeem the stored coupons from the registered consumers. The point of sale system transmits the captured information to the advertisement management platform, in real time, for validating the stored coupons and enabling redemption of the stored coupons for the retail transactions. The electronic commerce management server or the transaction management server removes the stored coupons from the mobile wallet application after the redemption of the stored coupons at the point of sale. The electronic commerce management server or the transaction management server tracks the exchange of the coupons and the electronic currency for retail transactions and stores the tracked information in a central data warehouse. In an embodiment, the mobile wallet application converts the electronic currency received as one or more of the incentives to equivalent airtime credit for mobile phone services and vice versa.

In an embodiment, the registered consumers are engaged with transactions of the coupons based on an incentive engagement plan of the advertisement distribution service. The incentive engagement plan requires each of the registered consumers to accept and redeem a predetermined number of incentives, for example coupons within a predetermined time period. For example, as part of the incentive engagement plan, the consumers are required to accept a certain number of coupons or vouchers per week. In addition, the consumers are also required to redeem a certain number of coupons or vouchers every week or every month, which may vary from week to week.

The advertisement management platform maintains the dynamic behavioral data of each of the registered consumers in the central data warehouse. The advertisement management platform regularly updates the dynamic behavioral data in the data warehouse for each engagement of the registered consumers with the targeted advertisements and each exchange of the incentives, for example, the coupons and the electronic currency for retail transactions. All usage data of the consumers are stored in the data warehouse. The data warehouse serves as a master catalog of all individual consumer behavioral and psychographic data, service interactions or responses of the consumer with targeted advertisements, coupon or voucher receipts, retail store coupon or voucher redemptions, all mobile wallet transactions including loyalty program transactions, virtual cash transactions, peer-to-peer transfers, mobile remittances including automated teller machine (ATM) transactions, micro-loans, etc. The data warehouse generates individual and collective consumer analytics information, for example, based on the usage data of the consumers, the tracked information on the exchange of coupons and electronic currency, the dynamic behavioral data of the consumers, etc.

In an embodiment, an analytics engine executable by at least one processor in the data warehouse proactively generates consumer analytics information using, for example, one or more of the consumer profile of each of the consumers, information on advertisement engagements and coupon engagements, and the tracked information of the exchange of the coupons and electronic currency by the registered consumers for retail transactions. The advertisement management platform selectively provides the generated consumer analytics information, for example, to one or more retailers, advertisers, and marketing and branding service providers. The consumer analytics may be used by the retailers, the advertisers, and the marketing and branding service providers to develop their advertisement campaigns based on the consumer analytics information. The consumer analytics information is made available to retailers and other advertising clients to allow them to develop their advertisement campaigns. The retailers and marketing and branding entities may optimize their market strategy with real time campaign information available in each consumer profile from the data warehouse.

In an embodiment, the mobile wallet application enables conversion of electronic currency to equivalent airtime credit for mobile phone services and vice versa. The electronic commerce management server and/or the transaction management server, in conjunction with the mobile wallet application, also provides support for additional electronic commerce services comprising, for example, loyalty programs, retail transactions, etc. In an embodiment, the virtual electronic currency is offered to the consumers as an incentive for completing a survey or a poll, as a unit for loyalty points as part of a loyalty program, for storing in the form of a cash equivalent for peer-to-peer remittances, and for micro-loan management.

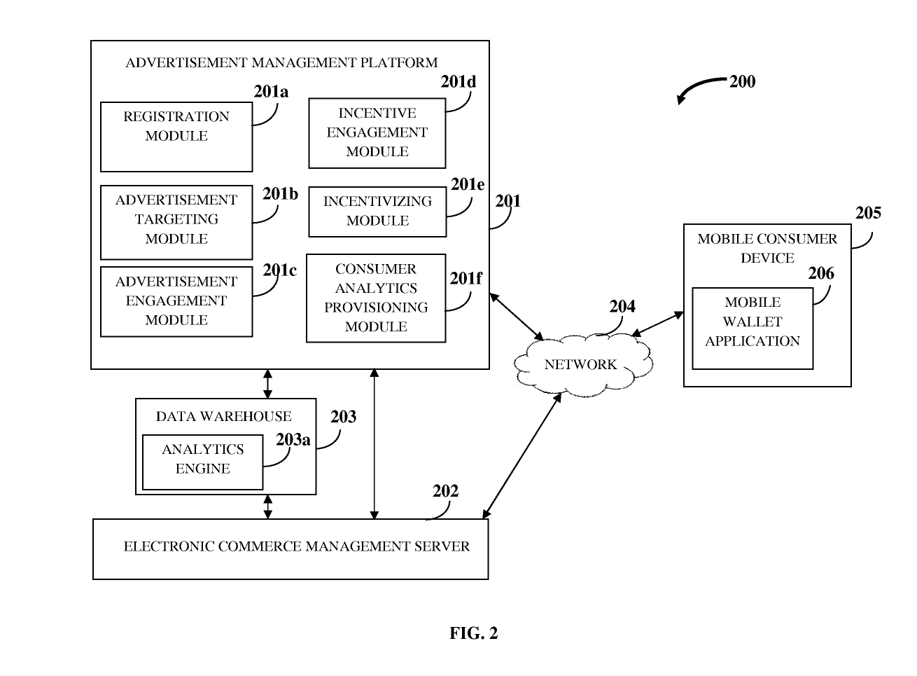

FIG. 2 illustrates a computer implemented system 200 for managing advertisements, electronic commerce, and consumer services. The computer implemented system 200 disclosed herein comprises an advertisement management platform 201, an electronic commerce management server 202, a mobile wallet application 206 provided on a consumer device 205 of the consumer, and a centralized data warehouse 203. The advertisement management platform 201 comprises at least one processor configured to execute the modules 201a, 201b, 201c, 201d, 201e, and 201f of the advertisement management platform 201. The components 201, 202, 206, and 203 of the computer implemented system 200 disclosed herein communicate with each other over a network 204. The network 204 is, for example, the internet, an intranet, a local area network (LAN), a wide area network (WAN), a communication network that implements Wi-Fi® of the Wireless Ethernet Compatibility Alliance, Inc., a cellular network, a mobile communication network, etc. The consumer device 205 is, for example, a personal computer, a laptop, a mobile phone such as the iPhone® of Apple Inc., a personal digital assistant, a tablet computing device such as the iPad® of Apple Inc., a global system for mobile communications (GSM) communication device or a code division multiple access (CDMA) communication device that utilizes unstructured supplementary service data (USSD), a wireless application protocol (WAP) browser or a mobile web browser for communicating with the advertisement management platform 201, a television with a digital set top box, a game console such as the PlayStation® of Sony Corporation, the Xbox® of Microsoft Corporation, the Nintendo® Wii®, other communication devices, etc.

The advertisement management platform 201 manages the advertisement distribution service for the consumers. The advertisement management platform 201 comprises a registration module 201a, an advertisement targeting module 201b, an advertisement engagement module 201c, an incentive engagement module 201d, an incentivizing module 201e, and a consumer analytics provisioning module 201f. The registration module 201a registers one or more of the consumers with the advertisement distribution service by creating a consumer profile for each of those consumers. The consumer profile comprises dynamic behavioral data of each of the registered consumers. The advertisement targeting module 201b targets advertisements to the registered consumers based on the dynamic behavioral data of the registered consumers through one or more of multiple media and communication channels.

The advertisement engagement module 201c engages the registered consumers with the targeted advertisements based on an advertisement engagement plan of the advertisement distribution service. The advertisement engagement plan requires each of the registered consumers to consume and provide a response to a predetermined number of targeted advertisements within a predetermined time period. The incentivizing module 201e incentivizes the registered consumers, that is, provides the registered consumers with one or more incentives, for example, one or more coupons and/or electronic currency when the response to one or more of the predetermined number of targeted advertisements confirms consumption of the targeted advertisements. The incentive engagement module 201d engages the registered consumers with transactions associated with the incentives based on the incentive engagement plan of the advertisement distribution service. The incentive engagement plan requires each of the registered consumers to accept and redeem a predetermined number of incentives, for example, coupons within a time period.

The advertisement management platform 201 is associated with a data warehouse 203 that maintains the dynamic behavioral data of each of the registered consumers. The data warehouse 203 updates the dynamic behavioral data regularly for each engagement of the registered consumers with the targeted advertisements and for each exchange of the incentives, for example, the coupons and the electronic currency for retail transactions. The computer implemented system 200 disclosed herein further comprises an analytics engine 203a, for example, in the data warehouse 203. The analytics engine 203a is executable by at least one processor for proactively generating consumer analytics information, for example, based on the dynamic behavioral data of the registered consumers, the advertisement and coupon engagements of the registered consumers, and tracked information on the exchange of the incentives, for example, the coupons and electronic currency for retail transactions.

The consumer analytics provisioning module 201f associated with the advertisement management platform 201 selectively provides consumer analytics and consumer information, for example, to one or more retailers, advertisers, and marketing and branding service providers. The consumer information comprises, for example, the consumer profile of each of the registered consumers, information on the advertisement and coupon engagements of the consumer, and the tracked information for the exchange of the coupons and electronic currency for retail transactions. The retailers, the advertisers, and the marketing and branding service providers may develop advertisement campaigns based on the consumer analytics. In an embodiment, the analytics engine 203a implements predictive analytics for predictively determining results of the advertisement campaigns and for predicting system utilization for advertising, incentive transmissions, and incentive redemptions for each of the advertisement campaigns.

The electronic commerce management server 202 is configured to communicate with the advertisement management platform 201. The electronic commerce management server 202 comprises at least one processor configured to manage electronic commerce services and consumer services for the consumers. The electronic commerce management server 202 communicates with the data warehouse 203 for tracking the exchange of the incentives, for example, the coupons and electronic currency for retail transactions and storing information on the tracking in the data warehouse 203. The electronic commerce management server 202 in conjunction with the mobile wallet application 206 provides additional electronic commerce services comprising, for example, loyalty programs and retail transactions.

The mobile wallet application 206 is configured to communicate with the advertisement management platform 201. The mobile wallet application 206 executable by at least one processor is provided to each of the registered consumers for storing the incentives, for example, the coupons and the electronic currency. The mobile wallet application 206, in communication with the electronic commerce management server 202, enables the exchange of the incentives for the retail transactions at a point of sale. The mobile wallet application 206, in communication with the electronic commerce management server 202, enables redemption of the coupons for goods and services at retail establishments and for purchasing airtime credit for mobile phone services.

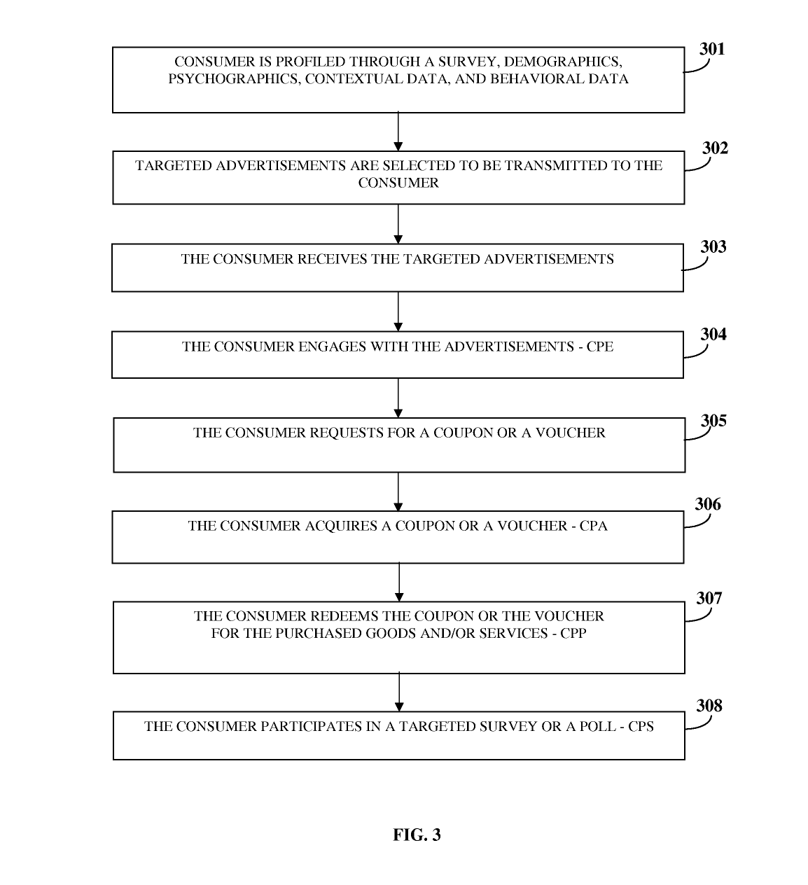

FIG. 3 exemplarily illustrates a flowchart comprising the steps for providing and utilizing the advertisement distribution service of the advertisement management platform 201 exemplarily illustrated in FIG. 2. The advertisement distribution service incorporates, for example, advertising to consumers using both visual and audio content through targeted advertising engagements referred to as cost per engagement (CPE); coupon or voucher distribution referred to as cost per acquisition (CPA); coupon or voucher redemption at retail locations referred to as cost per purchase (CPP); and a targeted survey or a poll referred to as cost per survey (CPS). A consumer is profiled 301 through an initial sign up survey during registration, demographics, psychographics, contextual data, and behavioral data. The advertisement management platform 201 selects 302 targeted advertisements to be transmitted to the consumer based on the consumer profile. The consumer receives 303 the targeted advertisements over different communication networks and media channels comprising, for example, an unstructured supplementary service (USSD) channel, wireless application protocol (WAP), mobile web, SMS, MMS, voice, the internet, television, etc. The consumer engages 304 with the advertisements following an advertisement engagement plan that stipulates that the consumer is required to engage with a predetermined number of advertisements within a predetermined time period. Each “advertisement engagement” refers to the requirement of the consumer to respond to the advertisement after consumption such that the response indicates or confirms the consumption of the advertisement. The consumer response may include a request 305 for a coupon or a voucher as an incentive for confirming the consumption of the advertisement. The consumer acquires 306 a coupon or a voucher and, in an embodiment, stores the coupon or the voucher in the mobile wallet application 206 on the consumer device 205. The consumer may then redeem 307 the coupon or the voucher for purchased goods and/or services, for example, via a USSD channel, WAP, mobile web, SMS, MMS, voice, the internet, television, etc. The consumer may also participate 308 in a targeted survey or a poll conducted by the advertisement management platform 201.

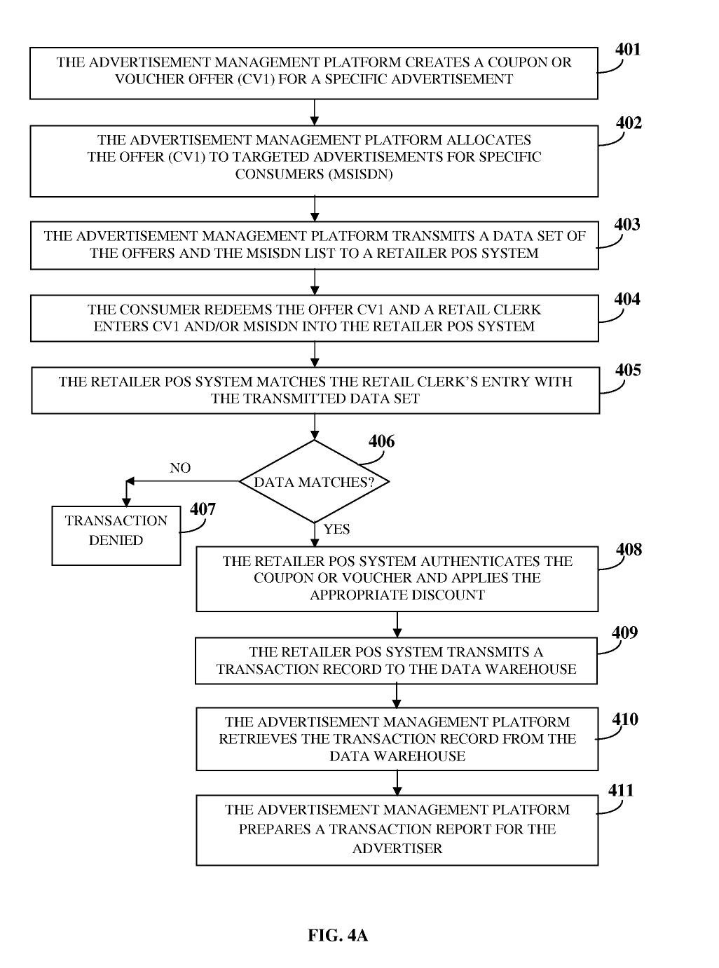

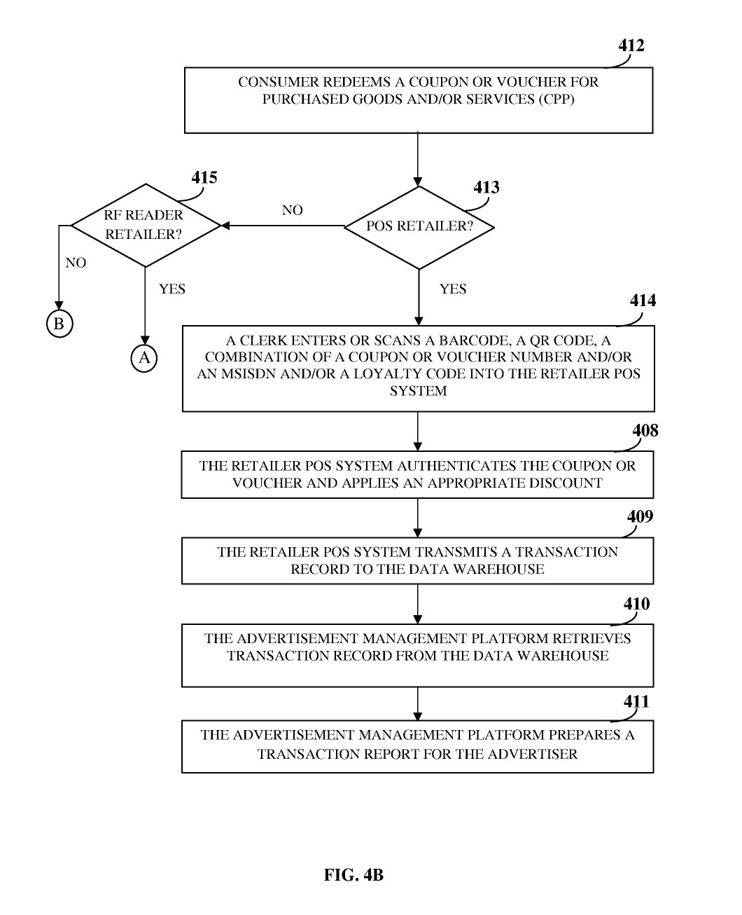

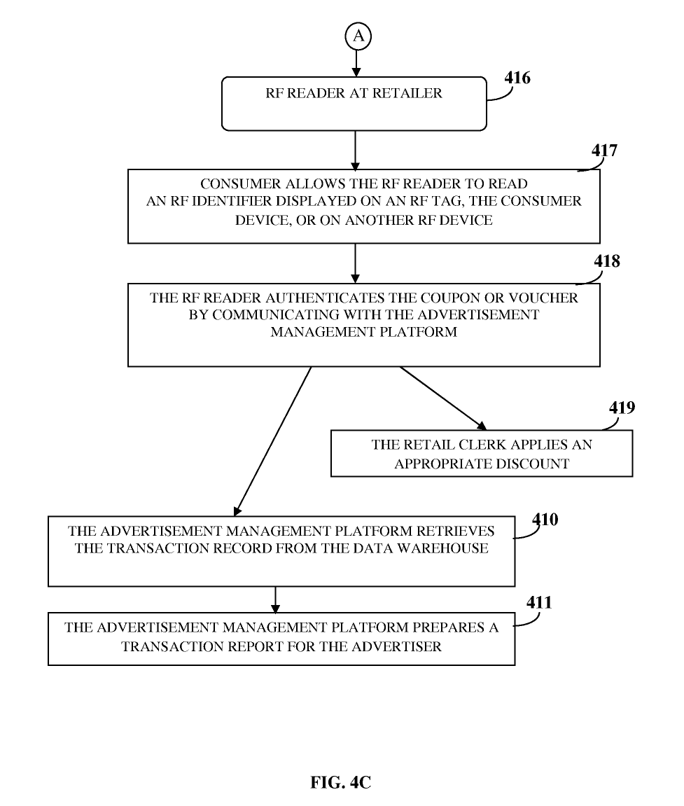

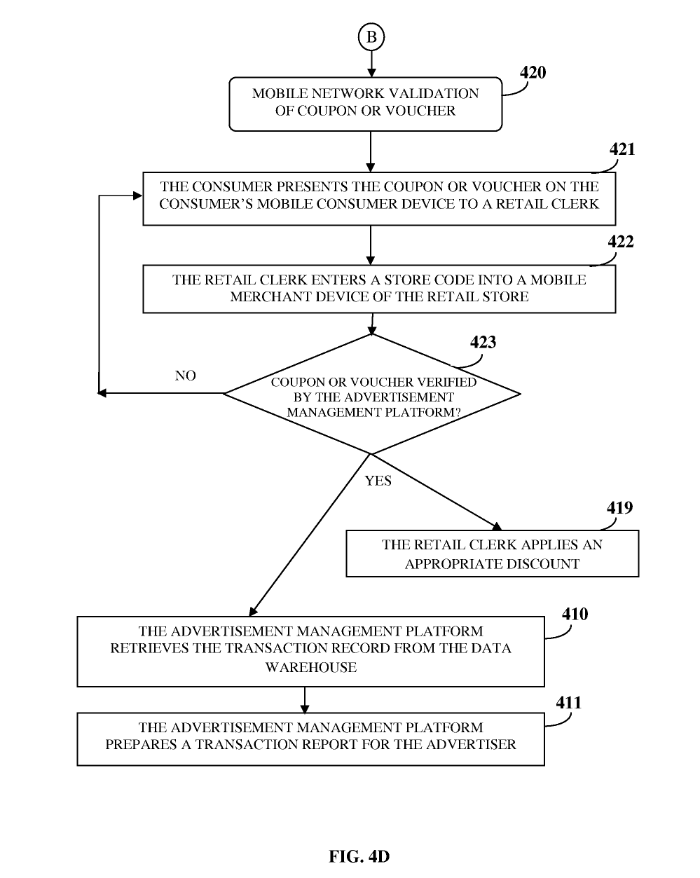

FIG. 4A exemplarily illustrates a flowchart of back end communication between the advertisement management platform 201, exemplarily illustrated in FIG. 2, and a point of sale (POS) for coupon or voucher redemptions. The advertisement management platform 201 creates 401 a coupon or voucher offer, for example, CV1, for a specific advertisement or advertisement campaign. The advertisement management platform 201 allocates 402 the offer CV1 to targeted advertisements for specific consumers, wherein each consumer is identified by a specific identifier, for example, the mobile subscriber integrated services digital network number (MSISDN) of the consumer device 205. The advertisement management platform 201 transmits 403 a data set of the offers and the MSISDN list to a retailer POS system. A consumer requests to redeem 404 the offer CV1 stored in the mobile wallet application 206 of the consumer device 205 at the POS, and a retail clerk enters 404 the offer code CV1 and/or the MSISDN of the consumer into the retailer POS system. The retailer POS system matches 405 the retail clerk's entry with the data set transmitted by the advertisement management platform 201. Depending on whether the offer code and/or the MSISDN entered matches 406 one or more entries of the data set, the transaction is either denied 407 or the coupon or voucher is authenticated 408. If the offer code and/or the MSISDN entered matches one or more entries of the data set, the retailer POS system authenticates 408 the coupon or voucher and applies 408 the appropriate discount for the purchased goods and/or services. The retailer POS system then transmits 409 a transaction record to the data warehouse 203 associated with the advertisement management platform 201 and the electronic commerce management server 202 via the network 204. The electronic commerce management server 202 removes the redeemed coupon or voucher from the mobile wallet application 206. The advertisement management platform 201 retrieves 410 the transaction record from the data warehouse 203 and prepares 411 a transaction report for the advertiser.

FIG. 4B exemplarily illustrates a flowchart of a front end transaction at a point of sale (POS) for redeeming coupons or vouchers according to the computer implemented method and system 200 exemplarily illustrated in FIG. 2 disclosed herein. The consumer may request to redeem 412 a coupon or voucher acquired and stored, for example, in the mobile wallet application 206 on the consumer device 205 from the advertisement management platform 201. Depending on the retailer POS system 413, a clerk at the POS manually enters or scans 414, for example, a barcode, a quick redemption (QR) code, a combination of a coupon or voucher number and/or the MSISDN of the consumer and/or the loyalty code into the retailer POS system, or utilizes 415 a radio frequency (RF) reader as disclosed in the detailed description of FIG. 4C. The retailer POS system communicates with the advertisement management platform 201 to authenticate 408 the coupon or voucher and applies 408 the appropriate discount for the purchased goods and/or services. The retailer POS system then transmits 409 a transaction record to the data warehouse 203 associated with the advertisement management platform 201 and the electronic commerce management server 202. The electronic commerce management server 202 removes the redeemed coupon or voucher from the mobile wallet application 206. The advertisement management platform 201 retrieves 410 the transaction record from the data warehouse 203 and prepares 411 a transaction report for the advertiser.

FIG. 4C exemplarily illustrates a flowchart of a transaction at a point of sale (POS) having a radio frequency (RF) reader 416 for redeeming coupons or vouchers. The consumer allows 417 the RF reader to read an RF identifier displayed on an RF tag, a display screen of the consumer device 205 exemplarily illustrated in FIG. 2, or on another RF device to determine the coupon or voucher identification code. The RF reader authenticates 418 the coupon or voucher by communicating with the advertisement management platform 201. After authentication, the retail clerk applies 419 an appropriate discount for the purchased goods and services. The advertisement management platform 201 retrieves 410 the transaction record containing information of the current transaction from the data warehouse 203 and prepares 411 a transaction report for the advertiser.

FIG. 4D exemplarily illustrates a flowchart of a transaction at a point of sale (POS) that uses unstructured supplementary service data (USSD), a wireless application protocol (WAP) browser, a mobile web browser session or other similar real time sessions for validating a coupon or a voucher. The real time sessions may also be conducted over other communication protocols comprising SMS, MMS, WAP, mobile web, and other cellular communications. For conducting a mobile network validation 420 of the coupon or voucher, the consumer presents 421 the coupon or voucher on the consumer's mobile consumer device 205 exemplarily illustrated in FIG. 2, to a retail clerk. The retail clerk enters 422 a store code into a mobile merchant device of the retail store in the ongoing session. The advertisement management platform 201 verifies 423 the coupon or the voucher. After verification, the retail clerk applies 419 an appropriate discount for the purchased goods and services. The advertisement management platform 201 retrieves 410 the transaction record containing information of the current transaction from the data warehouse 203 and prepares 411 a transaction report for the advertiser.

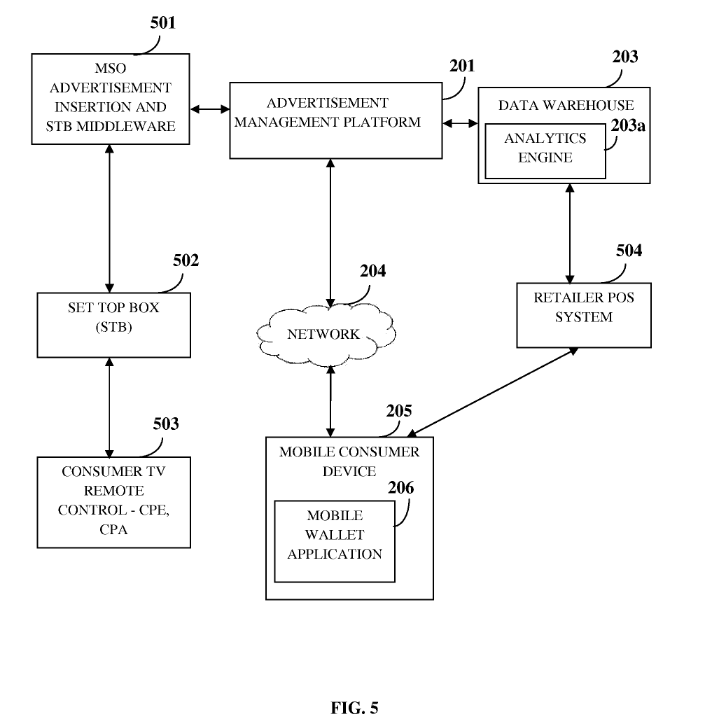

FIG. 5 exemplarily illustrates an embodiment of the advertisement distribution service, advertisement engagement, and coupon engagement of the advertisement management platform 201, exemplarily illustrated in FIG. 2, in association with a managed service organization (MSO). An MSO advertisement insertion and set top box (STB) middleware 501, herein referred to as the STB middleware 501, is provided in communication with the advertisement management platform 201. When a consumer registers for the advertisement distribution service with the MSO, the consumer may register through different options. In an example, the consumer selects channel 100 on a consumer television (TV) remote control 503 and uses the TV remote control 503 to sign up and register on-screen or calls a toll-free customer service number provided by the MSO to register for a new consumer account. Once the consumer completes a profile questionnaire of, for example, about ten to twenty questions during the on-screen interaction or provides responses to questions asked by a customer service phone representative, the consumer must agree to the opt-in terms of service (ToS). The advertisement management platform 201 then locks the set top box (STB) 502 to a specific channel, for example, channel 100, with a new password for the new consumer account.

The consumer then permits other household members to create their own sub-accounts with their own passwords following the same steps for a new registration. The consumer experience with the MSO minors what a consumer must do on the internet when the consumer logs on to a web account. After all the consumers in the household have registered, the consumer browses the program guide and selects programs, as the consumer would typically do with their TV remote control 503. Upon registration, the consumer receives a mobile wallet (m-wallet) application 206 used for redeeming coupons, that is sent to their mobile consumer device 205, for example, a smart phone or through electronic mail (email) for download, by the advertisement management platform 201 via the network 204. If the consumer does not possess a smart phone, the consumer is provided a mobile wallet account that the consumer can use with their standard mobile phone. The consumer's typical viewing experience remains unchanged with the exception that that the set top box channel number is fixed on a specific channel as determined by the MSO.

The advertisement engagement plan according to the embodiment of FIG. 5 provides advances in the consumer's experience. Firstly, the consumer is locked to a specific channel, for example, channel 100 on the set top box 502 and begins to receive advertisements at the normal advertisement interval times which have been specifically identified and targeted for that individual consumer. Each individual consumer will have a completely different advertising experience based on inter alia the dynamic behavioral data of the consumer. Secondly, each advertisement displays an advertisement question or offers a meta-tagged coupon, for example, on a lower third of the television screen. In an embodiment, this question may also be asked using a text-to-speech (TTS) engine at the same time for the visually impaired. Finally, the consumer uses the television remote control 503 to answer the question on the television screen. If the television remote control 503 is temporarily out of order or if the set top box 502 is not capable of a two-way interaction, the consumer can respond using the mobile wallet application 206 on the mobile consumer device 205.

Generally, a consumer only has to respond, for example, by pressing buttons corresponding to a selection “A” for Yes, “B” for No, or “C” for Ignore or other answer options to the questions on-screen, or by using a text-to-speech (TTS) engine in the mobile wallet application 206. Each time the consumer interacts with a targeted advertisement or coupon offer, the consumer accrues loyalty points. When the consumer accrues a certain number of loyalty points, the consumer is rewarded, for example, with a product or a service from the MSO, the advertiser, or both. When the consumer takes the time to respond to an advertisement targeted to the consumer with any of the options “A”, “B” or “C”, the consumer accrues loyalty points just for responding to the advertisements. In an embodiment, more loyalty points are accrued for a positive response, for example, option “A” or “Yes” than for option “B” or “No” or other answer options, while fewer points are accrued for “C” or “Ignore/I don't know” response, which has the least point accrual value. The consumer may review and redeem their loyalty points using the mobile wallet application 206. The loyalty point and rewards classification structure of the computer implemented method and system 200 disclosed herein is configured to meet the requirements of each MSO.

All consumer interactions are tracked, managed and analyzed by a predictive analytical algorithm implemented by the analytics engine 203a in the data warehouse 203 for advertising clients in real time. As used herein, the term “advertising clients” represent clients for the administrators of the advertisement management platform 201 and the electronic commerce management server 202, and comprise, for example, advertisers, retailers, and the marketing and branding service providers who seek to develop and implement advertisement campaigns by utilizing the advertisement management platform 201 of the computer implemented system 200 disclosed herein. The administrators of the advertisement management platform 201 and the electronic commerce management server 202 may provide services to the advertising clients for an appropriate remuneration or on a contract basis. In an embodiment, the consumer data is used to predict the result of a specific advertising campaign, prior to the launch of the advertising campaign. These predictive analytics are used both as a sales mechanism for demonstrating, in a strict analytic manner, the results an advertising client can expect from an advertising campaign, as well as a tool for predicting system utilization for advertising, coupon transmissions, and coupon redemptions from a specific advertising campaign. For example, if the advertising client contracts for 100,000 coupon redemptions, the analytics engine 203a predictively determines the number of advertisements that must be transmitted to a specific audience for achieving the goal of 100,000 coupon redemptions. Since the advertisement distribution service of the advertisement management platform 201 is related to the advertising results, the predictive analytical algorithm of the analytics engine 203a provides analytical insights into the expected results from a targeted advertising campaign.

The individual consumer data is available to the advertising clients on a per-campaign basis, for example, within about 24 hours of an advertisement campaign going live on television. Along with the feedback on the individual consumer responses to the targeted advertisements, the analytics or the results of the advertisement campaign are made available to the advertising clients anytime through the consumer analytics provisioning module 201f exemplarily illustrated in FIG. 2. These analytics comprising consumer targeting insight on the existing advertisement campaign are valuable to the advertising clients and allow them to effectively manage and target their existing and future advertisement campaigns.

When the consumer decides to redeem a coupon provided for an advertisement engagement through the set top box 502, the consumer automatically receives this coupon in their mobile wallet application 206. When the consumer decides to redeem the coupon in a retail store, the consumer opens the mobile wallet application 206, retrieves the coupon from a mobile wallet folder in the mobile wallet application 206, and provides the coupon to a cashier at the check-out counter, where the cashier can scan the coupon into the retailer point of sale (POS) system 504. If the consumer does not possess a smart phone, the consumer retrieves the same coupon from their non-smart phone mobile wallet application 206 instead. In an embodiment, a list of earned coupons may be retrieved, for example, from an unstructured supplementary service data (USSD) or WAP or mobile web menu on the mobile wallet application 206 of the consumer device 205. The consumer selects a coupon from the list in the USSD or WAP or mobile web menu on the mobile wallet application 206 and shares its alphanumeric code with the cashier. The cashier then types this alphanumeric code into the retailer POS system 504 to redeem the coupon. The advertisement management platform 201 integrates with point of sale (POS) retail systems worldwide and settles the coupon dynamically in real time with the resident mobile wallet application 206 or the non-smart phone USSD or WAP or mobile web mobile wallet. The advertising client is then notified of all coupon conversions for a particular advertisement campaign in real time via the consumer analytics provisioning module 201f, which serves as an advertisement campaign tool for the advertising clients.

In an embodiment, the advertisement management platform 201 provides the consumer with a proprietary mobile wallet application 206 deployable on a mobile consumer device 205, for example, a smart phone, a global system for mobile communications (GSM) cellular phone or a code division multiple access (CDMA) cellular phone that utilizes unstructured supplementary service data (USSD), a WAP browser or a mobile web browser for communicating with the advertisement management platform 201, etc., for managing and redeeming coupons, points, rewards, other incentives, etc., for sending and/or receiving virtual cash, for coupon sharing with friends on social networking platforms such as Facebook®, Twitter®, etc. Consider an example where a consumer initiates registration for the advertisement distribution service using a smart phone, for example, the iPhone® of Apple Inc. The consumer may register through different options. For example, the consumer can download the smart phone mobile wallet application 206 from the Apple store of Apple Inc., an Android® applications store of Google, Inc., or another smart phone mobile or web application storefront, and follow the in-application steps via the smart phone. Alternatively, the consumer may access a dedicated web page of the advertisement management platform 201 using a web browser on the consumer device 205 via the network 204, for example, the internet and follow the steps for downloading the mobile wallet application 206 on the consumer device 205 and setting up a web mobile wallet account.

The consumer may also call a toll-free customer service number associated with the advertisement management platform 201 to register for the advertisement distribution service and have the mobile wallet application 206 sent to the consumer's smart phone. Once the consumer completes a profile questionnaire containing, for example, about five to ten questions during the in-application steps, on the web page, or on the phone interaction with a customer service representative, the consumer is requested to agree to the opt-in terms of service (ToS) of the advertisement management platform 201. On agreeing to the opt-in ToS, the consumer is officially registered with the advertisement distribution service provided by the advertisement management platform 201. The consumer experience with the smart phone mobile wallet application 206 mirrors what a consumer can do on the Internet when the consumer uses the web mobile wallet account. Upon registration, the consumer receives the smart phone mobile wallet application 206 sent, for example, to the consumer's smart phone or sent through electronic mail (email) for download. If the consumer does not possess a smart phone, the advertisement management platform 201 creates a mobile wallet account that the consumer can use with a standard consumer device 205 such as a mobile phone or their web account or web mobile wallet account.

The advertisement engagement plan according to the embodiment of the smart phone mobile wallet application 206 provides advances in consumer experience. For example, the consumer begins to receive advertisements at typical advertisement interval times, which have been specifically identified and targeted for that individual consumer by the advertisement management platform 201, even if the smart phone mobile wallet application 206 and the web page is not open on the consumer's smart phone. The advertisement management platform 201 provides each individual consumer with a different advertising experience from the next consumer. In another example, each advertisement displays an advertisement question on the consumer's smart phone. The advertisement question may appear, for example, as a pop-up question in the smart phone mobile wallet application 206 or the web browser. These advertisement questions may also appear, for example, as “growl” messages. Growl messages, supported by the Open Source group of The Growl Project, are notification messages supported by the Macintosh (MAC) operating system (OS) X of Apple Inc., and Microsoft Windows® of Microsoft Corporation. In an embodiment, the advertisement question may also be asked using a text-to-speech (TTS) engine at the same time for visually impaired consumers. The consumer then uses the smart phone mobile wallet application 206 or the web browser to provide a response to the question on the smart phone or web screen. If the smart phone mobile wallet application 206 or the web browser has no mobile network data or internet connection, the session is temporarily stored or cached in the consumer's smart phone and reappears when the mobile network data or the internet connection is reconnected.

The smart phone mobile wallet application 206 enables the consumer to enter a response to an advertisement question, for example, by pressing buttons corresponding to a selection “A” for “Yes” or another answer option, a selection “B” for “No” or another answer option, or a selection “C” for “Ignore” or another answer option on a screen of the consumer's smart phone, or through a text-to-speech (TTS) engine in the smart phone mobile wallet application 206. Every time the consumer interacts with the targeted advertisement or coupon offer, the consumer generates loyalty points, which are automatically updated in their mobile wallet account. When the consumer accrues a certain number of loyalty points, the consumer is rewarded with a product or a service, for example, from a retailer, an advertiser, or a third party provider. When the consumer takes the time to respond to any targeted advertisement with any of the options “A”, “B” or “C”, the consumer accrues loyalty points just for responding to the advertisements. In an embodiment, more points are accrued for option “A” or “Yes” responses than for option “B” or “No” responses, while fewer points are accrued for “C” or “Ignore/I don't know” or another answer option responses which have the least point accrual value.

The consumer can review and redeem the loyalty points stored in the mobile wallet application 206 through the smart phone or the web browser. The loyalty point and rewards classification structure of the computer implemented method and system 200 disclosed herein is configured to the requirements of each smart phone. The consumer interactions are tracked, managed and analyzed by a predictive analytical algorithm implemented by the analytics engine 203a in the data warehouse 203 for advertising clients in real time. The individual consumer data is available on a per-campaign basis to a campaign advertiser, for example, within about 24 hours of an advertisement campaign becoming live in the smart phone mobile wallet application 206 or the web browser. Along with the feedback on the individual responses to the advertisement distribution service, the result of the advertisement campaign is made available to the advertising clients anytime through the consumer analytics provisioning module 201f. These analytics are valuable for providing consumer targeting insight on the existing campaign to allow the advertising clients to manage and target the advertiser's future campaigns.

When the consumer decides to redeem a coupon obtained by engaging with an advertisement on the smart phone mobile wallet application 206 or the web browser, the consumer automatically receives this coupon in their smart phone mobile wallet application 206, in the web browser, or in the standard mobile wallet account. When the consumer decides to redeem the coupon in a retail store, the consumer invokes the smart phone mobile wallet application 206, retrieves the coupon from a mobile wallet folder of the smart phone, and provides the coupon to a cashier at a check-out counter, where the cashier can scan the coupon into the retail point of sale (POS) system 504. When a consumer does not possess the smart phone mobile wallet application 206, the consumer retrieves the same coupon from their non-smart phone mobile wallet application 206. The consumer selects the coupon from the list in the USSD or WAP or mobile web mobile wallet menu and shares the alphanumeric code with the cashier. The cashier then types this alphanumeric code into the retailer POS system 504 to redeem the coupon. The advertisement management platform 201 integrates with point of sale (POS) retail systems worldwide and settles the coupon dynamically in real time with either the resident smart phone mobile wallet application 206 or the non-smart phone USSD or WAP or mobile web mobile wallet. When the retailer is not integrated with the advertisement management platform 201 or does not have the retailer POS system 504, the consumer can still redeem their barcode, quick redemption (QR) code or near field communication (NFC) based coupon at the retail store, directly from the smart phone mobile wallet application 206. Typical phone consumers can obtain a retail rewards NFC card for an additional fee to use with these unsupported or non-POS retailers. The advertiser is notified of all coupon conversions for a particular campaign in real time via the advertisement campaign tool of the consumer analytics provisioning module 201f.

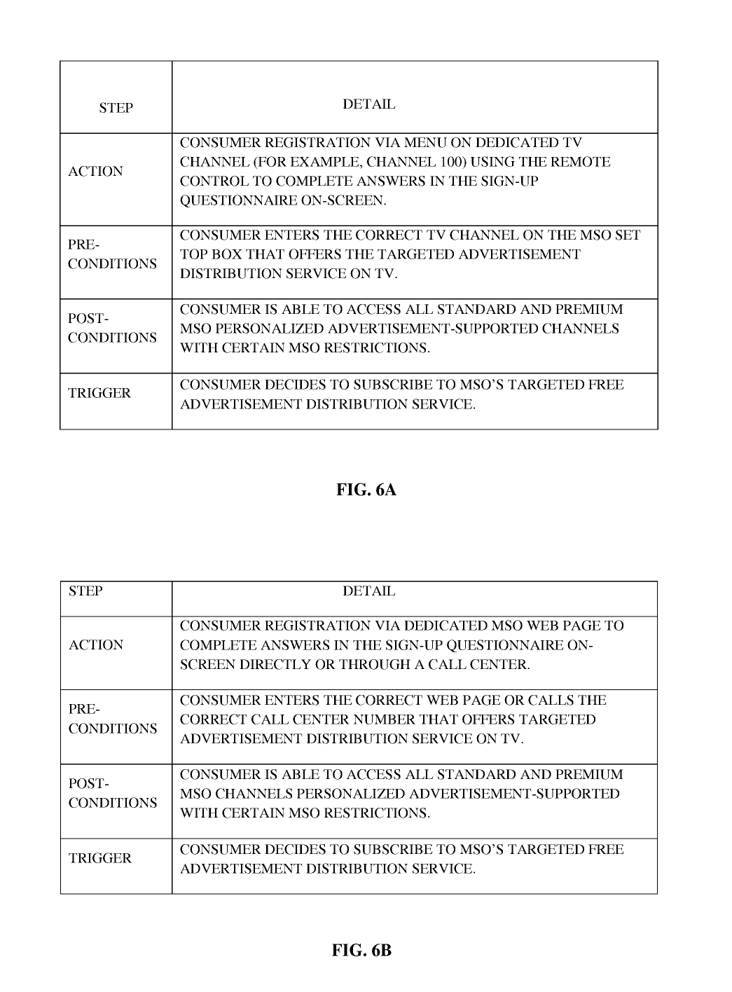

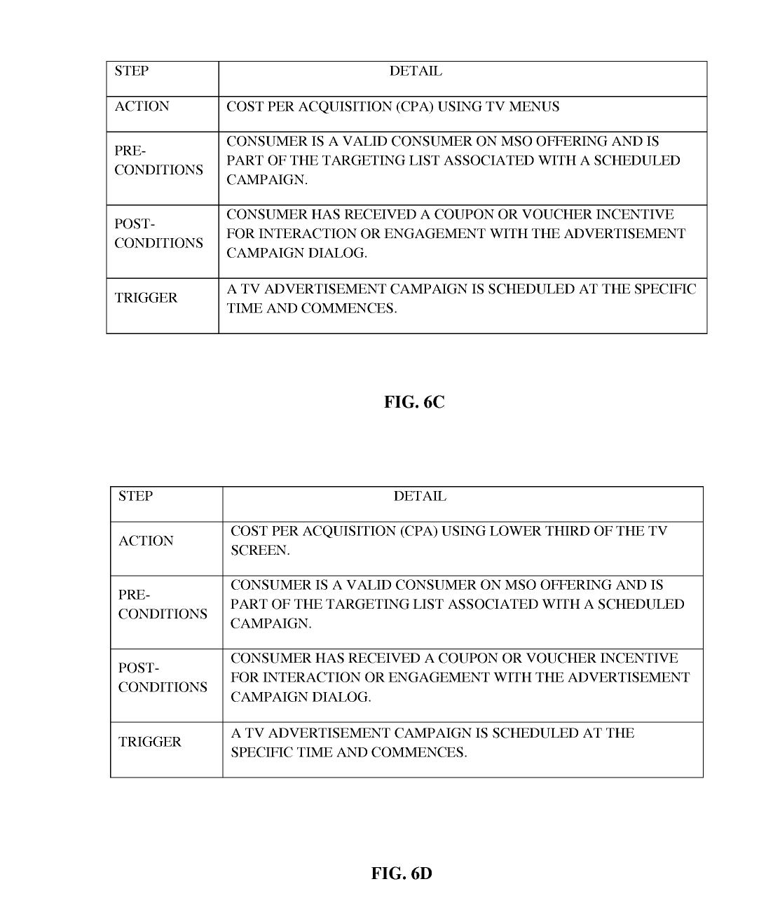

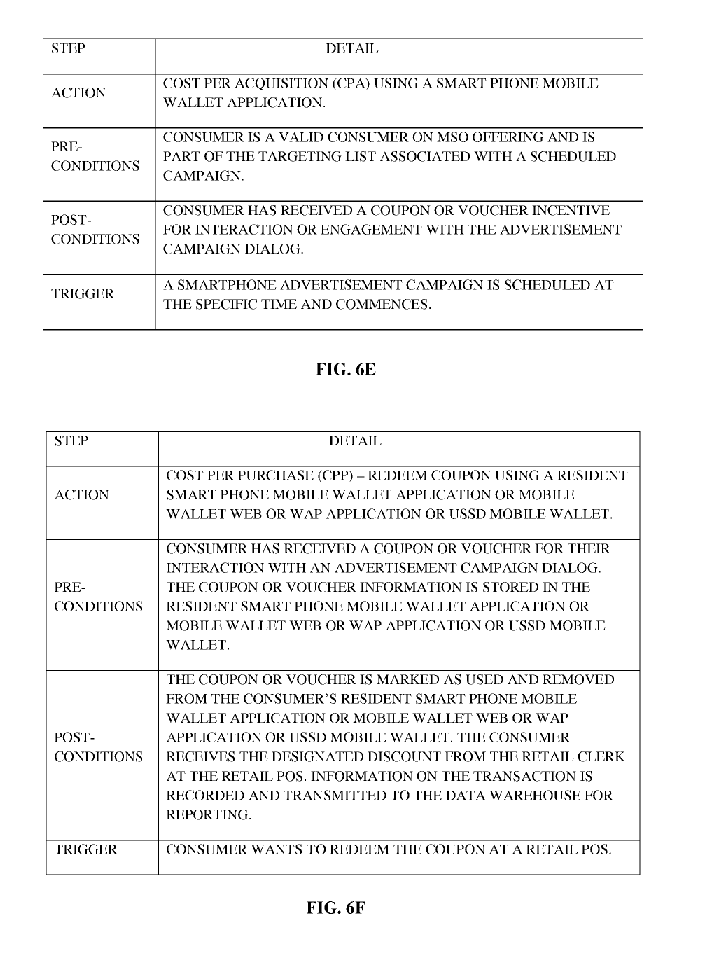

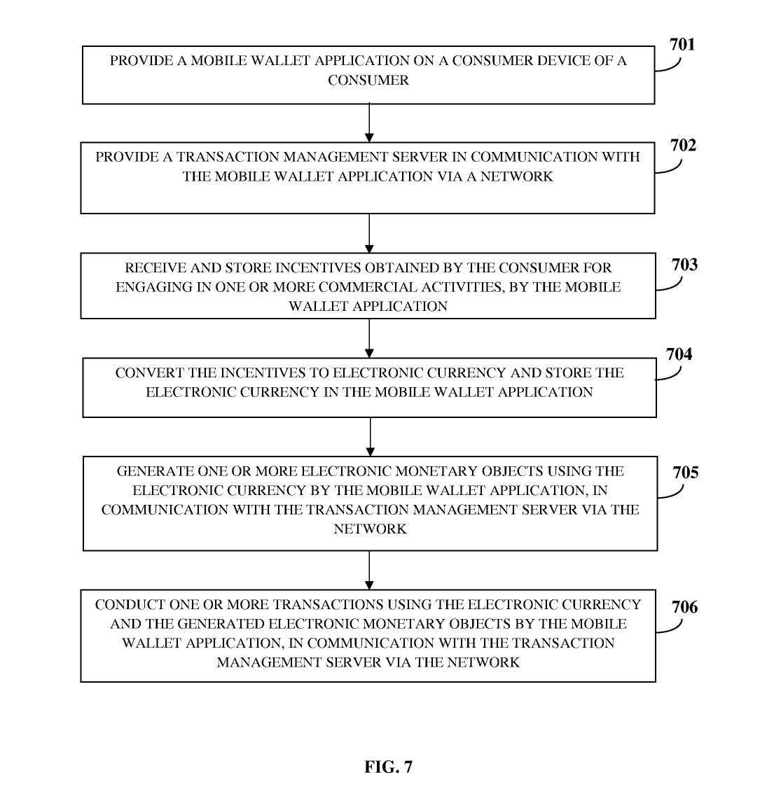

FIG. 6A exemplarily illustrates a use case describing consumer registration for the advertisement distribution service provided by the advertisement management platform 201 through a managed service organization (MSO) set top box (STB) 502, exemplarily illustrated in FIG. 5, on a television screen. When a consumer decides to subscribe to the MSO's targeted advertisement distribution service provided by the advertisement management platform 201, the consumer may enter a television (TV) channel on the MSO set top box 502 that offers the targeted advertisement distribution service on television, using a remote control 503. The advertisement management platform 201 registers the consumer with the advertisement distribution service via a television menu on the dedicated television (TV) channel, for example, channel 100 that is accessed by the consumer using the remote control 503 to complete answers in a sign-up questionnaire on-screen. If the consumer has an existing mobile subscriber integrated services digital network number (MSISDN), the advertisement management platform 201 collects and registers the MSISDN on the advertisement management platform 201. Alternatively, the consumer provides a validated electronic mail (email) address to the advertisement management platform 201, or the advertisement management platform 201 assigns a new MSISDN for the consumer device 205 of the consumer.

The advertisement management platform 201 captures consumer data, for example, through the STB middleware 501. The advertisement management platform 201 automatically enters the consumer data into a customer relationship management (CRM) application of the advertisement management platform 201. The consumer data is migrated into the data warehouse 203. After an email validation, the advertisement management platform 201 enables the advertisement distribution service for the consumer, thereby providing access to all standard and premium MSO personalized advertisement-supported channels with certain MSO restrictions. The advertisement management platform 201 also sends the mobile wallet application 206 for storing and managing coupons to the email address of the consumer and the consumer device 205, for example, as a hypertext markup language 5 (HTML5) web link, for the consumer to download.

If the consumer does not download the mobile wallet application 206, the consumer can access the coupons, for example, through a USSD or WAP or mobile web based mobile wallet menu. The advertisement management platform 201 captures additional consumer information and interests during consumer interactions through the set top box 502 via the remote control 503 and updates the consumer profile of the consumer. The advertisement management platform 201 captures this consumer information within the customer relationship management application of the advertisement management platform 201 and eventually transmits this consumer information to the data warehouse 203 for reference. The consumer is then provisioned on the MSO network with a default advertisement-supported service plan. The consumer receives a confirmation email, and/or a USSD or SMS text confirmation of the new MSO service.

FIG. 6B exemplarily illustrates a use case describing consumer registration for the advertisement distribution service provided by the advertisement management platform 201 exemplarily illustrated in FIG. 5, through a managed service organization (MSO) using a web portal or a call center. When a consumer decides to subscribe to the MSO's targeted advertisement distribution service provided by the advertisement management platform 201, the consumer initiates registration via a dedicated MSO web page that offers the targeted advertisement distribution service on television directly, or by contacting a call center. The consumer enters a uniform resource locator (URL) of the MSO web page or calls the number of the call center using the consumer device 205, for example, a smart phone, a global system for mobile communications (GSM) cellular phone or a code division multiple access (CDMA) cellular phone that utilizes unstructured supplementary service data (USSD), a WAP browser, or a mobile web browser for communicating with the advertisement management platform 201, etc. The consumer or a MSO customer service representative (CSR) logs, for example, on to the dedicated web customer relationship management (CRM) application page to complete answers in a sign-up questionnaire. If the consumer has an existing mobile subscriber integrated services digital network number (MSISDN), the advertisement management platform 201 collects and registers the MSISDN on the advertisement management platform 201. Alternatively, the consumer provides a validated email address to the advertisement management platform 201, or the advertisement management platform 201 assigns a new MSISDN for the consumer device 205 of the consumer.

The consumer or the customer service representative (CSR) automatically enters consumer data into the customer relationship management (CRM) application of the advertisement management platform 201. The consumer data is migrated into the data warehouse 203. After an email validation, the advertisement distribution service is enabled for the consumer, which provides access to all standard and premium MSO personalized advertisement-supported channels with certain MSO restrictions. The advertisement management platform 201 sends the mobile wallet application 206 for storing and managing coupons to the email address of the consumer and the consumer device 205 for the consumer to download. If the consumer does not download the mobile wallet application 206, the consumer can access the coupons through the unstructured supplementary service data (USSD), WAP or mobile web based mobile wallet menu. The advertisement management platform 201 captures additional consumer information and interests during consumer interactions through the customer relationship management (CRM) application web page and then transmits this consumer information to the consumer profile in the data warehouse 203 for reference. The consumer is then provisioned on the MSO network with a default advertisement-supported service plan. The consumer receives a confirmation email, and/or a USSD or SMS text confirmation of the new MSO service.

FIG. 6C exemplarily illustrates a use case describing a scenario where a consumer is targeted by the advertisement management platform 201 exemplarily illustrated in FIG. 5, to engage in an advertisement campaign dialog through television menus for acquiring coupons or vouchers. The advertisement management platform 201 checks whether the consumer is a valid consumer on a managed service organization (MSO) offering and whether the consumer is part of a targeting list associated with a scheduled advertisement campaign. The consumer receives an initial delivery of a television based advertisement campaign dialog scheduled at a specific time, through the set top box 502. The consumer responds by engaging with the advertisement campaign dialog and selecting one of the presented options. If the consumer chooses to “Ignore” a coupon, the advertisement management platform 201 stores this response in the consumer profile of the consumer and the question is scheduled to be re-sent at a later time.

If the consumer chooses to “Review” the coupon, the advertisement campaign dialog continues until the advertisement campaign dialog reaches a point where an incentive or a reward is defined. For example, the incentive is a coupon or a voucher redeemable for a 10% discount on the consumer's next purchase at a specific store. The consumer then “Accepts” or “Rejects” the coupon and the advertisement management platform 201 stores the response in the consumer profile. The incentivizing module 201e, exemplarily illustrated in FIG. 2, requests a coupon or a voucher from the batch that was associated with this reward point when the dialog and advertisement campaign were created in the advertisement management platform 201. The incentivizing module 201e provides an available coupon or voucher to the consumer and marks the coupon or voucher as “Active”. In an embodiment, the advertisement management platform 201 transmits the coupon or voucher to the mobile wallet application 206 of the consumer. The advertisement management platform 201 concludes the advertisement campaign dialog when the consumer is informed, for example, via email, the mobile wallet application 206, and/or the USSD text notification of the incentive or the reward that the consumer just received.

FIG. 6D exemplarily illustrates a use case describing a scenario where a consumer is targeted by the advertisement management platform 201 exemplarily illustrated in FIG. 5, to engage in an advertisement campaign dialog on a television screen for acquiring coupons or vouchers. Based on a television advertisement campaign scheduled for advertisement delivery at specific times, the consumer receives a delivery of a television based advertisement campaign dialog, for example, on a lower third of the television screen. The consumer receives the advertisements when the consumer is registered for the managed service organization (MSO) offering and is part of the targeting list associated with the scheduled campaign. The consumer receives a coupon or voucher incentive for interacting or engaging with the advertisement campaign dialog.

FIG. 6E exemplarily illustrates a use case describing a scenario where a consumer is targeted by the advertisement management platform 201 exemplarily illustrated in FIG. 5, to engage in an advertisement campaign dialog on the mobile wallet application 206 deployed on a mobile consumer device 205 or a web browser for acquiring coupons or vouchers. The mobile consumer device 205 is, for example, a smart phone, a global system for mobile communications (GSM) or a code division multiple access (CDMA) cellular phone that utilizes unstructured supplementary service data (USSD), a WAP browser, or a mobile web browser for communicating with the advertisement management platform 201, etc. Based on a smart phone advertisement campaign scheduled for advertisement delivery a few times or at specific times, the consumer receives a delivery of a smart phone based advertisement campaign dialog. The consumer receives the advertisements when the consumer is registered for the managed service organization (MSO) offering and is part of the targeting list associated with the scheduled campaign. The consumer receives a coupon or a voucher incentive as well as a specific loyalty point value for each coupon or voucher, in the smart phone mobile wallet application 206 for interacting or engaging with the advertisement campaign dialog.

FIG. 6F exemplarily illustrates a use case describing a scenario where a consumer redeems a coupon or a voucher at a retail point of sale (POS) using the mobile wallet application 206 exemplarily illustrated in FIG. 2. The consumer accesses the resident smart phone mobile wallet application 206, or the mobile wallet web or WAP application, or an unstructured supplementary service data (USSD) mobile wallet menu and selects a mobile wallet folder option. The advertisement management platform 201 presents the consumer with a list of mobile wallet content items and selects the coupon or voucher that the consumer wishes to redeem. The consumer scans the selected coupon or voucher barcode or a quick redemption (QR) code displayed on the smart phone mobile wallet application 206 to a point of sale (POS) reader, or provides the selected coupon using the other methods disclosed herein. Alternatively, the consumer shows or provides a unique coupon identifier (ID) to a retail clerk at the retail POS. The retail clerk automatically or manually verifies that coupon or voucher is valid for redemption at the retail POS store. The advertisement management platform 201 performs processing of the post-conditions exemplarily illustrated in FIG. 6F. That is, the electronic commerce management server 202 marks and removes the coupon or voucher from the consumer's resident smart phone mobile wallet application 206 or mobile wallet web or WAP application or USSD mobile wallet. The consumer receives a designated discount from the retail clerk at the retail POS. The retail clerk provides a discounted product against a product stock keeping unit (SKU) and checks-out the consumer. The integrated retail POS system provider records the consumer transaction data and transmits the consumer transaction data to the data warehouse 203 for reporting. The consumer receives, for example, an unstructured supplementary service data (USSD) or a short message service (SMS) notification that the transaction was performed.

Consider another example, where a registered consumer acquires a coupon or a voucher from the advertisement management platform 201 for confirming consumption of one or more advertisements delivered to the consumer by the advertisement management platform 201. The coupon or voucher is stored in the mobile wallet application 206 of the consumer. Subsequently, when the consumer redeems that coupon or voucher at a retail establishment, the coupon or voucher is removed from the mobile wallet application 206, since the coupon or voucher has been redeemed to make a purchase or to obtain a discount. The value of the coupon or voucher is either deducted from the check out total at the retailer cash register, or alternatively could be credited back to the mobile wallet application 206 in the form of additional airtime credit, virtual cash, and/or loyalty points.

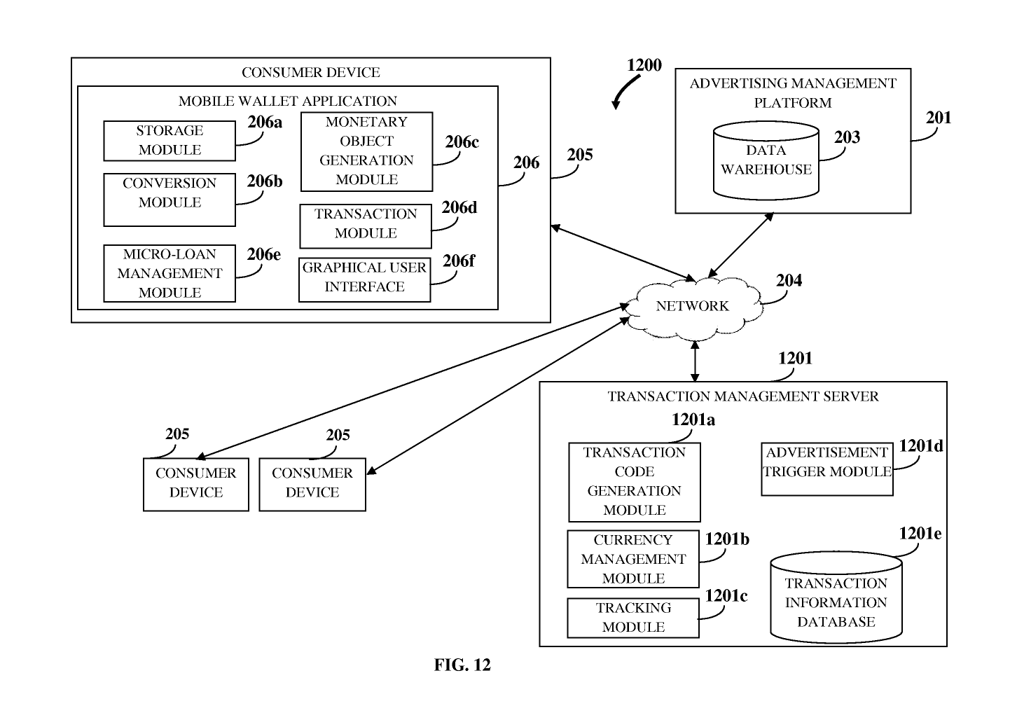

FIG. 7 illustrates a computer implemented method for managing electronic currency of a consumer. The computer implemented method disclosed herein provides 701 a mobile wallet application 206 executable by at least one processor on a consumer device 205 of the consumer, as exemplarily illustrated in FIG. 2 and FIG. 12. The consumer device 205 is, for example, a mobile phone, a laptop, a personal digital assistant (PDA), a tablet computer, etc. The computer implemented method disclosed herein provides 702 a transaction management server, in communication with the mobile wallet application 206 via a network 204. The transaction management server comprises at least one processor configured to manage the electronic currency of the consumer. The network 204 is, for example, the internet, an intranet, a local area network, a wide area network, a communication network implementing Wi-Fi® of the Wireless Ethernet Compatibility Alliance, Inc., a cellular network, a mobile communication network, etc.

The mobile wallet application 206 receives and stores 703 incentives obtained by the consumer for engaging in one or more commercial activities. As used herein, the term “commercial activities” refers to activities performed by the consumer, which provide monetary benefit to the consumer. The commercial activities engaged by the consumer comprise, for example, purchasing a product and/or a service, responding to a targeted advertisement, completing a survey, completing a poll, opting in for a loyalty program, submitting a review, etc., and any combination thereof. The incentives are, for example, in the form of virtual electronic currency, reward points, etc. The incentives are, for example, offered to the consumers for completing a survey or a poll, as a unit for loyalty points as part of a loyalty program, as a cash-equivalent for peer-to-peer remittances or peer-to-peer cash transactions, for micro-loan management, etc. The peer-to-peer cash transactions performed by the mobile wallet application 206 in communication with the transaction management server via the network 204, offer a cardless personal identity number (PIN) based peer-to-peer cash transferring service, in which consumers send and receive electronic money via the transaction management server over the network 204, and upload and withdraw physical money, for example, using automated teller machines (ATMs). In an example, the mobile wallet application 206 receives and stores the incentives obtained by the consumer for engaging in one or more commercial activities from a marketing entity or the transaction management server via the network 204. The term “marketing entity” refers to an advertiser, a business enterprise, etc., that offers special values or discounts to the consumer in the form of redeemable coupons, points, etc., for promoting products or services.

The mobile wallet application 206 converts 704 the incentives to electronic currency and stores the electronic currency in the mobile wallet application 206. The electronic currency is a monetary unit that can be used by the consumer for conducting a financial transaction electronically over the network 204, for example, the internet. The mobile wallet application 206 generates 705 one or more electronic monetary objects using the electronic currency, in communication with the transaction management server via the network 204. As used herein, the term “electronic monetary object” refers to a monetary unit that can be exchanged by the consumer for receiving a commercial service, for example, a mobile communication service, a retail service, etc., over the network 204, for example, the internet. The electronic monetary objects comprise, for example, cash, airtime credit, mobile remittances at national and international levels, etc. The term “cash”, for example, refers to physical cash, virtual cash, etc. The term “airtime credit”, for example, refers to prepaid mobile phone charges remitted for mobile communication services. For example, the mobile wallet application 206 performs conversion of the electronic currency to equivalent cash or equivalent airtime credit for a mobile communication service.

Consider an example where a consumer receives an incentive of 200 reward points for purchasing a product at an online electronic goods portal. The mobile wallet application 206 converts the incentive of 200 reward points to electronic currency worth $150, based on an agreement between the electronic goods portal and providers of the mobile wallet application 206 in communication with the transaction management server via the network 204. The mobile wallet application 206, in communication with the transaction management server via the network 204, generates one or more electronic monetary objects, for example, cash, airtime credit, etc., using the electronic currency of $150. The transaction management server enters into an agreement with multiple third party entities, for example, telecommunication service providers, banking institutions, electronic shopping portals, etc., for establishing the terms and conditions for converting the electronic currency to a required electronic monetary object. For example, providers of the transaction management server establish an agreement with a telecommunication service provider for establishing the rate of conversion of the electronic currency to airtime credit. In this example, the mobile wallet application 206 proportions $50 of electronic currency for generation of a cash monetary object and $100 of electronic currency for generation of an airtime credit monetary object and maintains a separate account for cash and airtime credit. Therefore, the mobile wallet application 206 allows the consumer to use the cash and airtime credit separately for different transactions. In this example, the mobile wallet application 206, in communication with the transaction management server via the network 204, converts the proportioned $100 in the airtime credit account to a predetermined number of units of airtime credit based on the agreement between the telecommunication service provider and the providers of the transaction management server.

The mobile wallet application 206, in communication with the transaction management server via the network 204, conducts 706 one or more transactions using, for example, the electronic currency, the generated electronic monetary objects, etc. The transaction management server, for example, acts as an intermediary between transacting entities, for example, between the consumers engaged in a financial transaction. The transaction management server authenticates transaction details of the transacting consumers. In an embodiment, the transaction management server maintains a separate account for each of the consumers who have registered with the transaction management server. The account comprises, for example, details of the transactions carried out by each of the consumers using the electronic currency and each of the electronic monetary objects. For example, the transaction management server maintains a complete history of all transactions carried out by a consumer using airtime credit. The airtime credit may, for example, comprise airtime minutes and/or a cash remittance.

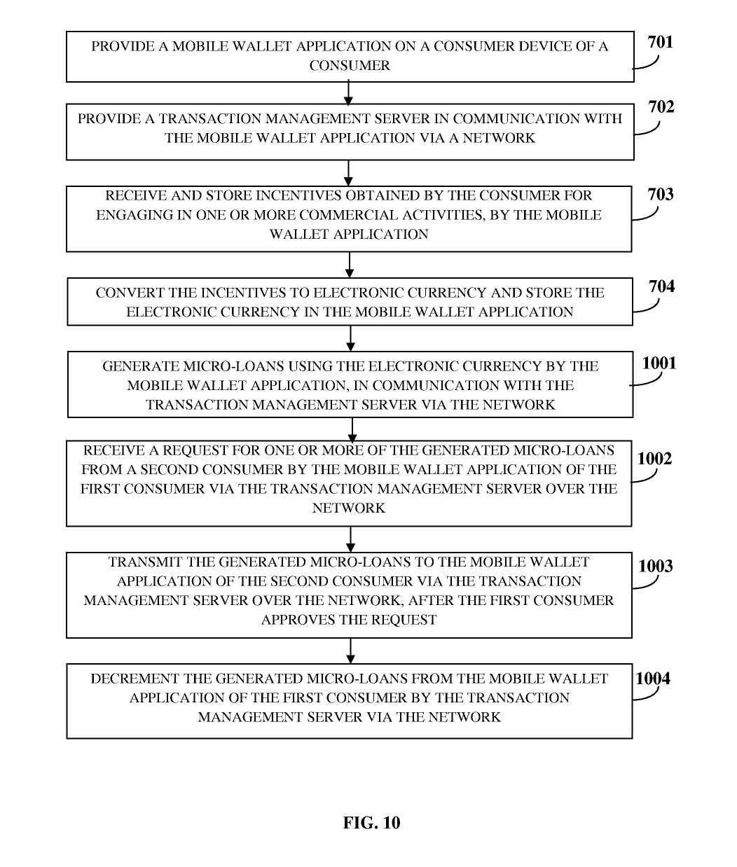

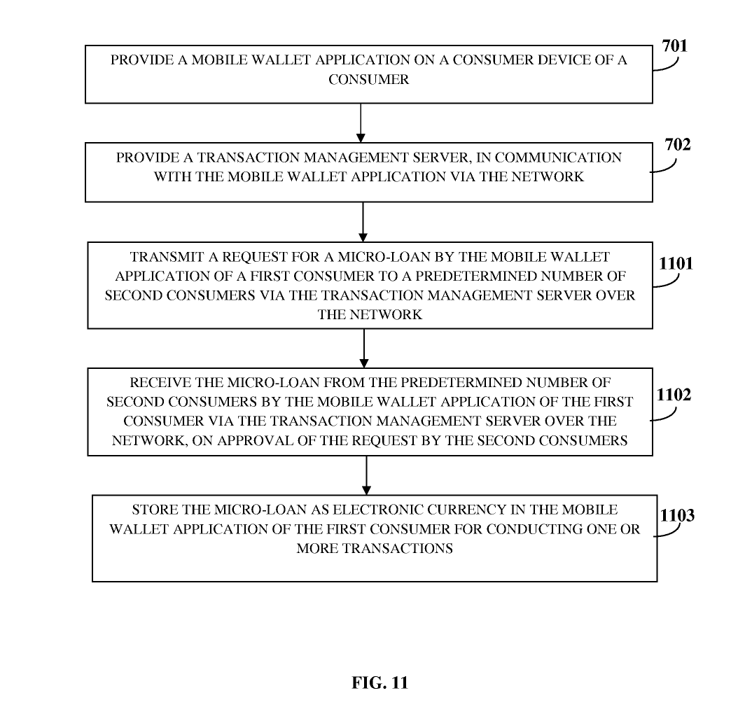

In an embodiment, the mobile wallet application 206 on the consumer device 205 of a first consumer, in communication with the transaction management server via the network 204, transfers electronic currency from the mobile wallet application 206 of the first consumer to a second consumer. In an example, the mobile wallet application 206 on the consumer device 205 of the first consumer stores mobile airtime received as a remittance in the form of virtual cash and transfers the virtual cash as electronic currency to a second consumer via the transaction management server over the network 204. Remittance amounts can be sent and received as airtime, which can then be stored in the mobile wallet application 206 as virtual cash. The mobile wallet application 206 allows the use of virtual cash as electronic currency as well as incentives, for example, loyalty points for retail store purchases. In another embodiment, the mobile wallet application 206 on the consumer device 205 of the first consumer, in communication with the transaction management server via the network 204, transfers the generated electronic monetary objects from the mobile wallet application 206 of the first consumer to the second consumer. In another embodiment, the mobile wallet application 206 on the consumer device 205 of the first consumer directly transfers the incentives, for example, coupons, from the mobile wallet application 206 of the first consumer to the second consumer via the transaction management server over the network 204. The transaction management server generates a transaction code for each of the transactions and transmits the generated transaction code to the mobile wallet application 206 on the consumer device 205 of the consumer via the network 204. In another embodiment, the mobile wallet application 206 allows a first consumer to conduct transactions for engaging in a loan transaction with one or more second consumers, via the transaction management server over the network 204, using the electronic currency configured as a micro-loan as disclosed in the detailed description of FIG. 10 and FIG. 11.

The transaction management server tracks information on the transactions and stores the tracked information in a data warehouse 203 exemplarily illustrated in FIG. 2 and FIG. 12. The usage data of the consumer is stored in the data warehouse 203. The data warehouse 203 serves as a master catalog, for example, of the consumer responses, the rewards awarded to the consumer, mobile wallet transactions comprising transactions associated with loyalty programs, transactions associated with the electronic currency and the electronic monetary objects, peer-to-peer transfers, mobile remittances, automated teller machine (ATM) transactions, micro-loans, etc.

In an embodiment, the computer implemented method disclosed herein allows multiple advertising entities to target advertisements to the consumer on receiving an indication from the transaction management server, during conduction of the transactions by the mobile wallet application 206. This enables the consumers to receive additional incentives during the conduction of the transactions, for example, by answering queries on the targeted advertisements. The advertisement management platform 201, exemplarily illustrated in FIG. 2 and FIG. 12, delivers advertisements to the consumers, for example, during electronic currency transactions, peer-to-peer transactions, mobile remittances, micro-loan transactions, etc. In another example, targeted advertisements are displayed on an automated teller machine (ATM) screen during a wait time of the uploading or encashment process.

The transaction management server in conjunction with the mobile wallet application 206 provides support for additional electronic commerce services comprising, for example, loyalty programs, micro-loans, electronic financial transactions, and peer-to-peer transactions. The mobile wallet application 206 entirely manages electronic micro-loans (e-micro-loans) and their social media components. In an embodiment, targeted advertisements are delivered to e-micro-loan sponsors and loanees.

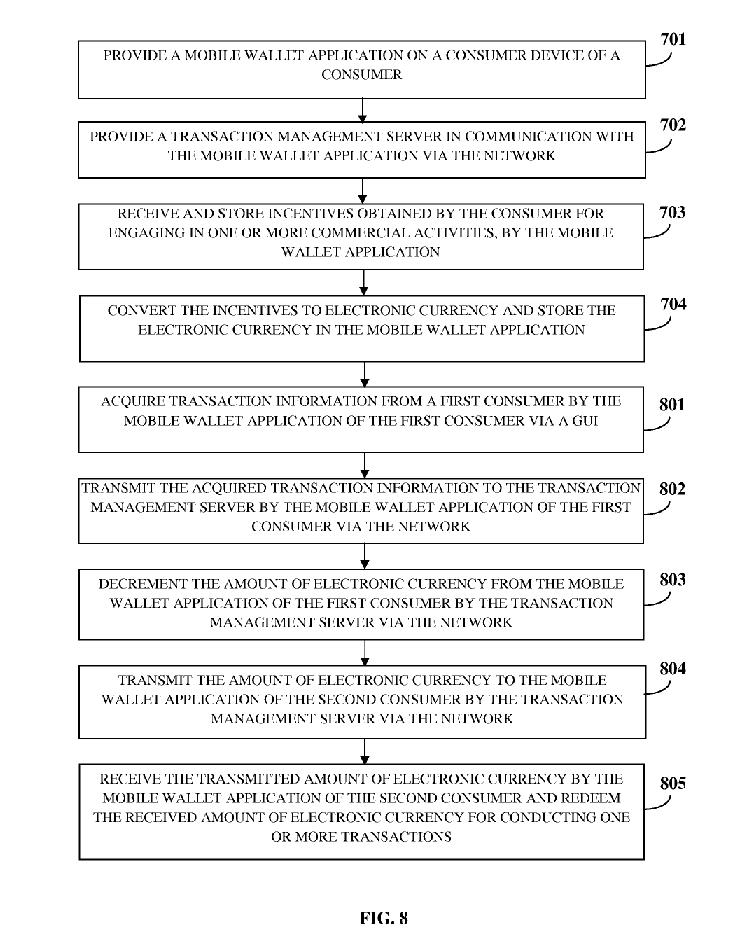

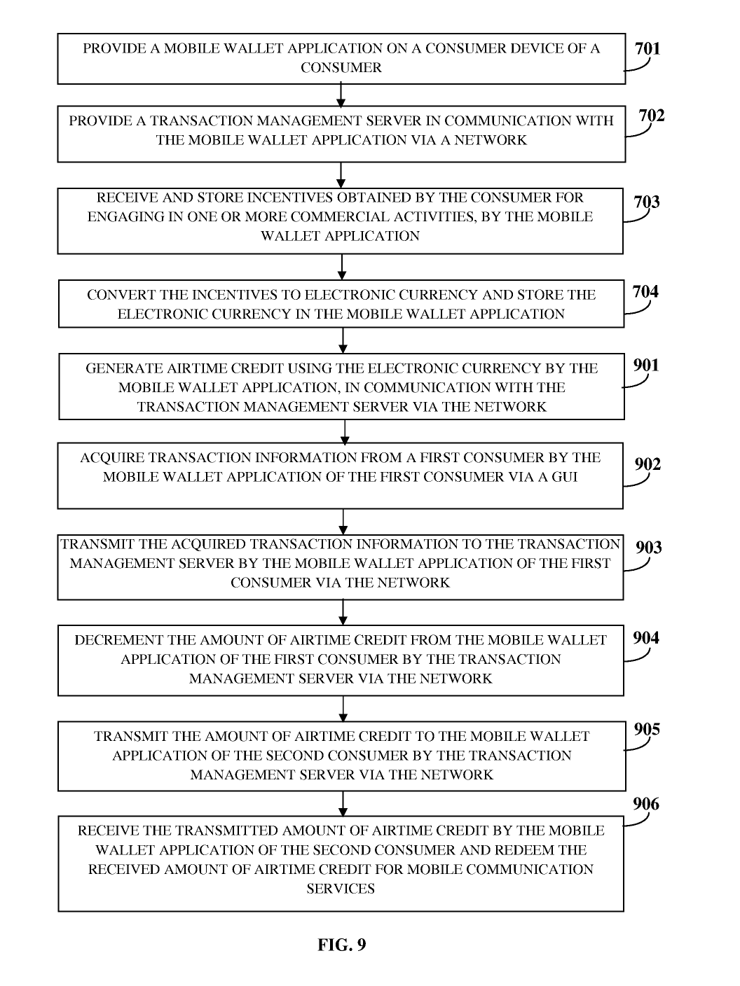

FIG. 8 exemplarily illustrates a first embodiment of the computer implemented method for managing electronic currency of consumers. The computer implemented method disclosed herein provides 701 the mobile wallet application 206 on a consumer device 205 of a consumer and provides 702 the transaction management server, in communication with the mobile wallet application 206 via the network 204 as disclosed in the detailed description of FIG. 7. The mobile wallet application 206, exemplarily illustrated in FIG. 2 and FIG. 12, receives and stores 703 incentives obtained by the consumer for engaging in one or more commercial activities as disclosed in the detailed description of FIG. 7. The mobile wallet application 206 converts 704 the incentives to electronic currency and stores the electronic currency in the mobile wallet application 206.

The mobile wallet application 206 of a first consumer acquires 801 transaction information from the first consumer via a graphical user interface (GUI) of the mobile wallet application 206. The transaction information comprises, for example, identification information of a second consumer and an amount of electronic currency that the first consumer intends to transfer to the second consumer. The identification information, for example, comprises the mobile subscriber integrated services digital network number (MSISDN), that is, the mobile number of the second consumer. The mobile wallet application 206 of the first consumer transmits 802 the acquired transaction information to the transaction management server via the network 204.

The transaction management server decrements 803 the specified amount of electronic currency from the mobile wallet application 206 of the first consumer via the network 204. The transaction management server generates a transaction code for identifying the transaction between the first consumer and the second consumer. The transaction management server transmits 804 the amount of electronic currency to the mobile wallet application 206 of the second consumer via the network 204. The mobile wallet application 206 of the second consumer receives 805 the transmitted amount of electronic currency and redeems the received amount of electronic currency for conducting one or more transactions, for example, conducting a micro-loan transaction, conducting a peer-to-peer remittance, exchanging the electronic currency for an item of value, converting the electronic currency to cash or airtime credit, etc.

FIG. 9 exemplarily illustrates a second embodiment of the computer implemented method for managing electronic currency of consumers. The computer implemented method disclosed herein provides 701 the mobile wallet application 206 on a consumer device 205 of the consumer and provides 702 the transaction management server, in communication with the mobile wallet application 206 via the network 204 as disclosed in the detailed description of FIG. 7. The mobile wallet application 206, exemplarily illustrated in FIG. 2 and FIG. 12, receives and stores 703 incentives obtained by the consumer for engaging in one or more commercial activities as disclosed in the detailed description of FIG. 7. The mobile wallet application 206 converts 704 the incentives to electronic currency and stores the electronic currency in the mobile wallet application 206.

The mobile wallet application 206, in communication with the transaction management server via the network 204, generates 901 airtime credit using the electronic currency. The mobile wallet application 206 enables conversion of the electronic currency to equivalent airtime credit for mobile phone services and reconversion of the airtime credit to equivalent electronic currency. For example, the mobile wallet application 206 directs a specified portion of the electronic currency towards airtime credit. The mobile wallet application 206 of the first consumer acquires 902 the transaction information from the first consumer via a graphical user interface (GUI) of the mobile wallet application 206. The transaction information comprises, for example, identification information of a second consumer, for example, the mobile phone number of the second consumer, and an amount of airtime credit to be transferred to the second consumer. The mobile wallet application 206 of the first consumer transmits 903 the acquired transaction information to the transaction management server via the network 204.

The transaction management server decrements 904 the amount of airtime credit from the mobile wallet application 206 of the first consumer via the network 204. Furthermore, the transaction management server establishes communication with a third party entity, for example, a telecommunication service provider that provides mobile communication services and transmits a notification stating the actual amount of airtime credit that needs to be deducted from a mobile account of the first consumer. The transaction management server generates a transaction code, for example, a transaction personal identification number (PIN) code for the airtime transaction between the first consumer and the second consumer, and transmits 905 the amount of airtime credit along with the transaction code to the mobile wallet application 206 of the second consumer via the network 204.

The mobile wallet application 206 of the second consumer receives 906 the transmitted amount of airtime credit and redeems the received amount of airtime credit for mobile communication services. In an embodiment, the mobile wallet application 206 of the second consumer converts the received amount of airtime credit to equivalent cash, for example, physical cash, electronic cash, etc., for conducting one or more transactions, for example, exchanging the cash for an item of value, conducting a micro-loan transaction, conducting a peer-to-peer transaction, etc. Consider an example where the mobile wallet application 206 enables transferring of the electronic cash from one of the registered consumers to another of the registered consumers for a peer-to-peer transaction via the transaction management server. The airtime credit, after transfer from the first consumer, can be converted to an equivalent amount of the electronic currency using the mobile wallet application 206 of the second consumer. The airtime credit received as remittance can be stored as electronic currency in the mobile wallet application 206 of the second consumer. The second consumer can transfer this electronic currency to another registered consumer. In an embodiment, targeted advertisements are inserted as part of a recipient notification used for each peer-to-peer remittance.

FIG. 10 exemplarily illustrates a third embodiment of the computer implemented method for managing electronic currency of consumers. The computer implemented method disclosed herein provides 701 the mobile wallet application 206 on a consumer device 205 of the consumer and provides 702 the transaction management server, in communication with the mobile wallet application 206 via the network 204 as disclosed in the detailed description of FIG. 7. The mobile wallet application 206, exemplarily illustrated in FIG. 2 and FIG. 12, receives and stores 703 incentives obtained by the consumer for engaging in one or more commercial activities. The mobile wallet application 206 converts 704 the incentives to electronic currency and stores the electronic currency in the mobile wallet application 206.

The mobile wallet application 206, in communication with the transaction management server via the network 204, generates 1001 micro-loans using the electronic currency. The micro-loan is, for example, a predefined amount of electronic currency. In this embodiment, the mobile wallet application 206 of the first consumer receives 1002 a request for one or more of the generated micro-loans from a second consumer via the transaction management server over the network 204. The mobile wallet application 206 of the first consumer transmits 1003 the generated micro-loans to the mobile wallet application 206 of the second consumer via the transaction management server over the network 204, after the first consumer approves the request.

The transaction management server decrements 1004 the generated micro-loans from the mobile wallet application 206 of the first consumer via the network 204. The transaction management server records the details of the micro-loan transaction, comprising, for example, the amount of electronic currency converted to a micro-loan and loaned to a particular consumer, the rate of interest for the micro-loan, etc. The transaction management server tracks the time duration from the receipt of the micro-loan by the specified consumer, the accumulated amount of electronic currency, rate of interest, etc., and issues a notification to the loanee and the sponsors.

FIG. 11 exemplarily illustrates a fourth embodiment of the computer implemented method for managing electronic currency of a consumer. The computer implemented method disclosed herein provides 701 the mobile wallet application 206 on a consumer device 205 of the consumer and provides 702 the transaction management server, in communication with the mobile wallet application 206 via the network 204 as disclosed in the detailed description of FIG. 7.

The mobile wallet application 206, exemplarily illustrated in FIG. 2 and FIG. 12, of a first consumer transmits 1101 a request for a micro-loan to a predetermined number of second consumers via the transaction management server over the network 204. The mobile wallet application 206 of the first consumer receives 1102 the micro-loan from the predetermined number of second consumers via the transaction management server over the network 204, on approval of the request by the second consumers. The mobile wallet application 206 of the first consumer stores 1103 the micro-loan as electronic currency in the mobile wallet application 206 for conducting one or more transactions, for example conducting a peer-to-peer remittance, exchanging the electronic currency for an item of value, converting the electronic currency to cash or airtime credit, etc.

Existing and potential consumers are entitled to apply for a micro-loan through a cooperative banking partnership in the local market. In an embodiment, before receiving approval of the request for a micro-loan, a first consumer requires a predetermined number of individuals, for example, active consumers registered with the advertisement management platform 201 and the transaction management server, to agree to sponsor the micro-loan debt of the first consumer as a precaution against defaults. The transaction management server defines a predetermined number of sponsor consumers required by the first consumer for sponsoring a debt of the micro-loan for the first consumer. The sponsor consumers are the consumers registered with the transaction management server who agree to sponsor the debt of the micro-loan for the first consumer. The mobile wallet application 206 of the first consumer transmits a sponsor request to the predetermined number of the sponsor consumers via the transaction management server over the network 204. The mobile wallet application 206 of the first consumer receives the micro-loan from the predetermined number of second consumers on acceptance of the sponsor request by the predetermined number of sponsor consumers who agree to sponsor the debt of the micro-loan for the first consumer. The transaction management server stores details of the active sponsor consumers who agree to sponsor the micro-loan debt of the first consumer in a transaction information database. In an embodiment, the transaction management server sends a notification regarding the agreement of the predetermined number of active sponsor consumers to sponsor the micro-loan debt of the first consumer to the second consumers who are willing to issue the micro-loan to the first consumer via the network 204. On receiving the notification, the second consumers transmit the micro-loan to the mobile wallet application 206 of the first consumer via the transaction management server over the network 204.

FIG. 12 exemplarily illustrates a computer implemented system 1200 for managing electronic currency of a consumer. The computer implemented system 1200 disclosed herein comprises a transaction management server 1201 in communication with a mobile wallet application 206 via a network 204. The transaction management server 1201 comprises at least one processor configured to manage the electronic currency of the consumer. In an embodiment, the electronic commerce management server 202 exemplarily illustrated in FIG. 2 and disclosed in the detailed description of FIG. 2, is configured to operate as the transaction management server 1201. The computer implemented system 1200 disclosed herein provides the mobile wallet application 206 on each of the consumer devices 205 of the consumers. The mobile wallet application 206 is executable by at least one processor configured to execute the modules 206a, 206b, 206c, 206d, and 206e of the mobile wallet application 206 on the consumer device 205 of the consumer. The network 204 is, for example, the internet, an intranet, a local area network, a wide area network, a communication network implementing WiFi® of the Wireless Ethernet Compatibility Alliance, Inc., a cellular network, a mobile communication network, etc.

The mobile wallet application 206 comprises a storage module 206a, a conversion module 206b, a monetary object generation module 206c, a transaction module 206d, a micro-loan management module 206e, and a graphical user interface (GUI) 206f. The storage module 206a receives and stores incentives, for example, reward points obtained by the consumer for engaging in one or more commercial activities. The conversion module 206b retrieves the incentives from the storage module 206a, converts the incentives to electronic currency, and transfers the electronic currency to the storage module 206a for storage. The storage module 206a stores the incentives and the electronic currency separately. In an embodiment, the conversion module 206b of the mobile wallet application 206 of a second consumer converts an amount of electronic currency, one or more of the generated electronic monetary objects, or any combination thereof received by the transaction module 206d of the second consumer's mobile wallet application 206 from the first consumer, for example, to equivalent cash for enabling the second consumer to conduct one or more transactions.

The monetary object generation module 206c, in communication with the transaction management server 1201 via the network 204, generates one or more electronic monetary objects, for example, cash, airtime credit, etc., using the electronic currency. The storage module 206a stores the electronic monetary objects separately from the incentives and the electronic currency in the mobile wallet application 206. The transaction module 206d, in communication with the transaction management server 1201 via the network 204, conducts one or more transactions using the electronic currency and/or the generated electronic monetary objects. In an embodiment, the transaction module 206d of the mobile wallet application 206 of a first consumer, in communication with the transaction management server 1201 via the network 204, transfers the electronic currency to a second consumer during conduction of the transactions. In another embodiment, the transaction module 206d of the mobile wallet application 206 of a first consumer, in communication with the transaction management server 1201 via the network 204, transfers the generated electronic monetary objects to a second consumer during conduction of the transactions.

In an embodiment, the transaction module 206d of the mobile wallet application 206 of a first consumer acquires transaction information comprising, for example, identification information of a second consumer, an amount of electronic currency, one or more of the generated monetary objects, or a combination thereof, to be transferred to the second consumer, etc., from the first consumer via the GUI 206f of the mobile wallet application 206. The transaction module 206d transmits the acquired transaction information to the transaction management server 1201 via the network 204. The transaction module 206d of the mobile wallet application 206 of the second consumer receives the amount of electronic currency, the generated electronic monetary objects, etc., and redeems the received amount of electronic currency, the generated electronic monetary objects, etc., for conducting one or more transactions.

The micro-loan management module 206e, in communication with the transaction module 206d and the transaction management server 1201 via the network 204, engages a first consumer in a loan transaction with one or more second consumers using the electronic currency configured as a micro-loan. In an example, the micro-loan management module 206e on the mobile wallet application 206 of a first consumer, in communication with the transaction management server 1201 via the network 204, generates micro-loans using the electronic currency. The micro-loan management module 206e on the mobile wallet application 206 of the first consumer receives a request for one or more of the generated micro-loans from a second consumer via the transaction management server 1201 over the network 204. The micro-loan management module 206e transmits the generated micro-loans to the mobile wallet application 206 of the second consumer via the transaction management server 1201 over the network 204, after the first consumer approves the request.

In another example, the micro-loan management module 206e on the mobile wallet application 206 of a first consumer transmits a request for a micro-loan to a predetermined number of second consumers via the transaction management server 1201 over the network 204. The micro-loan management module 206e receives the micro-loan from the predetermined number of second consumers via the transaction management server 1201 over the network 204, on approval of the request by the second consumers. The micro-loan management module 206e stores the micro-loan as electronic currency in the storage module 206a of the mobile wallet application 206 of the first consumer for conducting one or more transactions. The micro-loan management module 206e of the mobile wallet application 206 of the first consumer transmits a sponsor request to a predetermined number of sponsor consumers via the transaction management server 1201 over the network 204. The micro-loan management module 206e of the mobile wallet application 206 of the first consumer receives the micro-loan from the predetermined number of second consumers on acceptance of the sponsor request by the predetermined number of sponsor consumers who agree to sponsor a debt of the micro-loan for the first consumer. The transaction management server 1201 defines the predetermined number of sponsor consumers required by the first consumer for sponsoring the debt of the micro-loan for the first consumer.

The transaction management server 1201 comprises a transaction code generation module 1201a, a currency management module 1201b, a tracking module 1201c, and a transaction information database 1201e. The transaction information database 1201e stores transaction information, for example, the mobile subscriber integrated services digital network number (MSISDN), identification information, account details, etc., of each of the consumers registered with the transaction management server 1201. The transaction code generation module 1201a generates a transaction code for each of the transactions between the consumers and transmits the generated transaction code to the mobile wallet application 206 on the consumer device 205 of each of the consumers via the network 204.

The tracking module 1201c tracks information on the transactions and stores the tracked information in the data warehouse 203. The data warehouse 203 is, for example, associated with the advertisement management platform 201, disclosed in the detailed description of FIGS. 1-2, via the network 204. In another example, the data warehouse 203 is a part of the advertisement management platform 201. The currency management module 1201b decrements an amount of electronic currency, one or more of the generated electronic monetary objects, or any combination thereof, from the mobile wallet application 206 of a first consumer, based on the transaction information acquired from the first consumer. The currency management module 1201b then transmits the decremented amount to the mobile wallet application 206 of a second consumer via the network 204.

In an embodiment, the transaction management server 1201 further comprises an advertisement trigger module 1201d. The advertisement trigger module 1201d triggers an indication to the advertisement management platform 201 for targeting advertisements to the consumer during conduction of one or more transactions. The advertisement management platform 201 in turn notifies multiple advertising entities that provide the targeted advertisements. The advertising entities target the advertisements to the consumer on receiving an indication from the advertisement trigger module 1201d, during conduction of the transactions by the mobile wallet application 206.

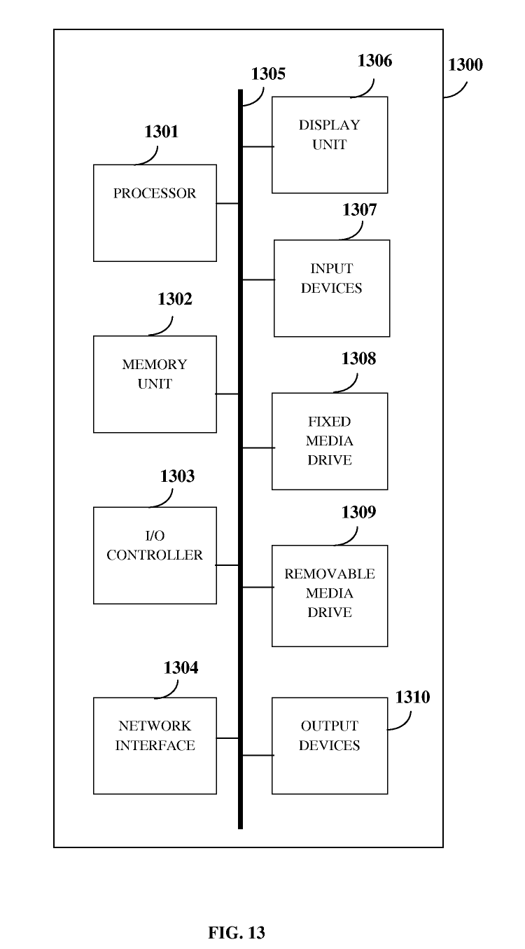

FIG. 13 exemplarily illustrates the architecture of a computer system 1300 employed by the advertisement management platform 201, the electronic commerce management server 202, the transaction management server 1201, and/or the consumer device 205 comprising the mobile wallet application 206, exemplarily illustrated in FIG. 2 and FIG. 12, for managing advertisements, electronic commerce, electronic currency, and consumer services. The computer system 1300 comprises, for example, a processor 1301, a memory unit 1302 for storing programs and data, an input/output (I/O) controller 1303, a network interface 1304, a data bus 1305, a display unit 1306, input devices 1307, a fixed media drive 1308, a removable media drive 1309 for receiving removable media, output devices 1310, etc.

The processor 1301 is an electronic circuit that executes computer programs. The memory unit 1302 stores programs, applications, and data. For example, the registration module 201a, the advertisement targeting module 201b, the advertisement engagement module 201c, the incentive engagement module 201d, the incentivizing module 201e, and the consumer analytics provisioning module 201f of the advertisement management platform 201 are stored in the memory unit 1302 of the computer system 1300 of the advertisement management platform 201. The storage module 206a, the conversion module 206b, the monetary object generation module 206c, the transaction module 206d, and the micro-loan management module 206e of the mobile wallet application 206 are stored in the memory unit 1302 of the computer system 1300 that deploys the mobile wallet application 206. The transaction code generation module 1201a, the tracking module 1201c, the currency management module 1201b, the advertisement trigger module 1201d, etc., of the transaction management server 1201 are stored in the memory unit 1302 of the computer system 1300 of the transaction management server 1201. The memory unit 1302 is, for example, a random access memory (RAM) or another type of dynamic storage device that stores information and instructions for execution by the processor 1301. The memory unit 1302 also stores temporary variables and other intermediate information used during execution of the instructions by the processor 1301. The computer system 1300 further comprises a read only memory (ROM) or another type of static storage device that stores static information and instructions for the processor 1301.

The network interface 1304 enables connection of the computer system 1300 to the network 204. The network 204 is, for example, a local area network (LAN), a wide area network, a mobile communication network, etc. The computer system 1300 of each of the advertisement management platform 201, the electronic commerce management server 202, and the transaction management server 1201 communicates, for example, with the mobile wallet application 206 on the consumer device 205 through their respective network interfaces 1304. The network interface 1304 comprises, for example, an infrared (IR) interface, a radio frequency (RF) interface, an interface that implements Wi-Fi® of the Wireless Ethernet Compatibility Alliance, Inc., a universal serial bus interface (USB), a local area network (LAN) interface, a wide area network (WAN) interface, etc. The I/O controller 1303 controls the input and output actions performed, for example, by the administrators of the advertisement management platform 201, the administrators of the transaction management server 1201, or the consumer using the consumer device 205. The data bus 1305 permits communication between the modules, for example, 201a, 201b, 201c, 201d, 201e, and 201f of the advertisement management platform 201, the modules 206a, 206b, 206c, 206d, 206e, etc., of the mobile wallet application 206, and the modules 1201a, 1201b, 1201c, 1201d, 1201e, etc., of the transaction management server 1201.

The display unit 1306 of the consumer device 205, via the GUI 206f displays the results of the operations performed by the mobile wallet application 206 to the consumer. The display unit 1306 of the consumer device 205 displays the advertisements targeted to each of the registered consumers by the advertisement management platform 201 based on the dynamic behavioral data of the registered consumers. The input devices 1307 are used for inputting data into the computer system 1300. The input devices 1307 are, for example, a keyboard such as an alphanumeric keyboard, a joystick, a pointing device such as a computer mouse, a touch pad, a light pen, etc. The output devices 1310 output the results of the operations computed by the mobile wallet application 206, for example, to the consumer using the consumer device 205.

Computer applications and programs are used for operating the computer system 1300. The programs are loaded onto the fixed media drive 1308 and into the memory unit 1302 of the computer system 1300 via the removable media drive 1309. In an embodiment, the computer applications and programs may be loaded directly via the network 204. Computer applications and programs are executed by double clicking a related icon displayed on the display unit 1306 using one of the input devices 1307.

The computer system 1300 of each of the advertisement management platform 201, the electronic commerce management server 202, the transaction management server 1201, and the consumer device 205 employs an operating system for performing multiple tasks. The operating system is responsible for management and coordination of activities and sharing of resources of the computer system 1300. The operating system further manages security of the computer system 1300, peripheral devices connected to the computer system 1300, and network connections. The operating system recognizes, for example, inputs provided by the consumer or an administrator using one of the input devices 1307, output display, files, and directories stored locally on the fixed media drive 1308. The operating system on the computer system 1300 executes different programs, for example, a web browser, an electronic mail (email) application, etc., initiated by the consumer through the consumer device 205, using the processor 1301. The operating system monitors the use of the processor 1301. The processor 1301 retrieves the instructions for executing the modules, for example, 201a, 201b, 201c, 201d, 201e, and 201f of the advertisement management platform 201, the modules 206a, 206b, 206c, 206d, 206e, etc., of the mobile wallet application 206 of the consumer device 205, and the modules 1201a, 1201b, 1201c, 1201d, 1201e, etc., of the transaction management server 1201 from the program memory in the form of signals. A program counter determines the location of the instructions in the program memory. The program counter stores a number that identifies the current position in the program of the modules, for example, 201a, 201b, 201c, 201d, 201e, and 201f of the advertisement management platform 201, the modules 206a, 206b, 206c, 206d, 206e, etc., of the mobile wallet application 206 of the consumer device 205, and the modules 1201a, 1201b, 1201c, 1201d, 1201e, etc., of the transaction management server 1201.

The instructions fetched by the processor 1301 from the program memory after being processed are decoded. The instructions are placed in an instruction register (IR) in the processor 1301. After processing and decoding, the processor 1301 executes the instructions. For example, the registration module 201a defines instructions for registering one or more consumers with the advertisement distribution service by creating a consumer profile for each of those consumers. The advertisement targeting module 201b defines instructions for targeting advertisements to the registered consumers based on the dynamic behavioral data of the registered consumers through one or more of multiple media and communication channels. The advertisement engagement module 201c defines instructions for engaging the registered consumers with targeted advertisements based on the advertisement engagement plan of the advertisement distribution service. The incentivizing module 201e defines instructions for providing the registered consumers with one or more incentives, for example, coupons and electronic currency when a response to one or more of the predetermined number of targeted advertisements confirms consumption of the targeted advertisements. The incentive engagement module 201d defines instructions for engaging the registered consumers with transactions associated with the incentives, for example, coupons based on the incentive engagement plan of the advertisement distribution service. The consumer analytics provisioning module 201f defines instructions for selectively providing consumer analytics information, for example, the consumer profile of each of the registered consumers, information on advertisement and coupon engagements, and tracked information of the exchange of the coupons and electronic currency for retail transactions, to one or more retailers, advertisers, and marketing and branding service providers. The mobile wallet application 206 defines instructions for storing incentives, for example, the coupons and the electronic currency and for enabling exchange of the coupons and the electronic currency for retail transactions using the electronic commerce management server 202 or the transaction management server 1201.

The data warehouse 203 associated with the advertisement management platform 201 defines instructions for maintaining the dynamic behavioral data of each of the registered consumers and updating the dynamic behavioral data regularly for each engagement of the registered consumers with the targeted advertisements and for each exchange of the incentives, for example, the coupons and the electronic currency for retail transactions. The analytics engine 203a defines instructions for proactively generating consumer analytics information, for example, based on the dynamic behavioral data of the registered consumers, the advertisement and coupon engagements of the registered consumers, and tracked information on the exchange of the incentives, for example, the coupons and electronic currency for retail transactions. Furthermore, the analytics engine 203a defines instructions for predictively determining results of the advertisement campaigns and for predicting system utilization for advertising, incentive transmissions, and incentive redemptions for each of the advertisement campaigns.

The storage module 206a of the mobile wallet application 206 defines instructions for receiving and storing incentives obtained by the consumer for engaging in one or more commercial activities. The conversion module 206b defines instructions for converting the incentives to electronic currency and storing the electronic currency in the storage module 206a. The conversion module 206b also defines instructions for converting an amount of electronic currency, one or more of the generated electronic monetary objects, or a combination thereof, to equivalent cash for conducting one or more transactions.

The monetary object generation module 206c defines instructions for generating one or more electronic monetary objects using the electronic currency. The transaction module 206d defines instructions for conducting one or more transactions, for example, using the electronic currency and/or the generated electronic monetary objects, in communication with the transaction management server 1201 via the network 204. The transaction module 206d defines instructions for transferring the electronic currency and/or the generated electronic monetary objects from a first consumer to a second consumer, in communication with the transaction management server 1201 via the network 204, during conduction of the transactions. Furthermore, the transaction module 206d defines instructions for acquiring transaction information from a first consumer via the GUI 206f of the mobile wallet application 206. The transaction module 206d defines instructions for transmitting the acquired transaction information to the transaction management server 1201 via the network 204. The transaction module 206d of the mobile wallet application 206 of a second consumer defines instructions for receiving the amount of electronic currency, one or more of the generated electronic monetary objects, or a combination thereof, and for redeeming the received amounts for conducting one or more transactions.

The micro-loan management module 206e defines instructions for engaging the first consumer in a loan transaction with one or more second consumers using the electronic currency configured as a micro-loan, in communication with the transaction module 206d and the transaction management server 1201 via the network 204. The micro-loan management module 206e defines instructions for generating micro-loans using the electronic currency. The micro-loan management module 206e defines instructions for receiving a request for one or more of the generated micro-loans from a second consumer via the transaction management server 1201 over the network 204. The micro-loan management module 206e defines instructions for transmitting the generated micro-loans to the mobile wallet application 206 of the second consumer via the transaction management server 1201 over the network 204, after the first consumer approves the request. The micro-loan management module 206e defines instructions for transmitting a request for a micro-loan to a predetermined number of second consumers via the transaction management server 1201 over the network 204 based on inputs received from a first consumer. The micro-loan management module 206e defines instructions for receiving the micro-loan from the predetermined number of second consumers via the transaction management server 1201 over the network 204, on approval of the request by the second consumers. The micro-loan management module 206e defines instructions for storing the micro-loan as electronic currency in the storage module 206a for conducting one or more transactions.

The micro-loan management module 206e of the mobile wallet application 206 of the first consumer defines instructions for transmitting a sponsor request to a predetermined number of sponsor consumers via the transaction management server 1201 over the network 204. The micro-loan management module 206e of the mobile wallet application 206 of the first consumer defined instructions for receiving the micro-loan from the predetermined number of second consumers on acceptance of the sponsor request by the predetermined number of sponsor consumers who agree to sponsor a debt of the micro-loan for the first consumer. The transaction management server 1201 defines instructions for defining the predetermined number of sponsor consumers required by the first consumer for sponsoring the debt of the micro-loan for the first consumer.

The transaction code generation module 1201a of the transaction management server 1201 defines instructions for generating a transaction code for each of the transactions and for transmitting the generated transaction code to the mobile wallet application 206 on the consumer device 205 of the consumer via the network 204. The tracking module 1201c defines instructions for tracking information on one or more transactions and for storing the tracked information in the data warehouse 203. The currency management module 1201b defines instructions for decrementing an amount of electronic currency, one or more of the generated electronic monetary objects, or a combination thereof, from the mobile wallet application 206 of a first consumer via the network 204 and transmitting the decremented amounts to the mobile wallet application 206 of a second consumer via the network 204, based on the transaction information acquired from the first consumer. The advertisement trigger module 1201d defines instructions for triggering an indication to the advertisement management platform 201 for targeting advertisements to the consumer during conduction of one or more transactions.

The processor 1301 of the advertisement management platform 201 retrieves the instructions defined by the registration module 201a, the advertisement targeting module 201b, the advertisement engagement module 201c, the incentive engagement module 201d, the incentivizing module 201e, the data warehouse 203, the analytics engine 203a, and the consumer analytics provisioning module 201f, and executes the instructions. The processor 1301 of the consumer device 205 retrieves the instructions defined by the storage module 206a, the conversion module 206b, the monetary object generation module 206c, the transaction module 206d, and the micro-loan management module 206e of the mobile wallet application 206 and executes the instructions. The processor 1301 of the transaction management server 1201 retrieves the instructions defined by the transaction code generation module 1201a, the currency management module 1201b, the tracking module 1201c, and the advertisement trigger module 1201d, and executes the instructions.

At the time of execution, the instructions stored in the instruction register are examined to determine the operations to be performed. The operations comprise, for example, arithmetic operations and logic operations. The processor 1301 then performs the specified operations. The operating system performs multiple routines for performing a number of tasks required to assign the input devices 1307, the output devices 1310, and memory for execution of the modules, for example, 201a, 201b, 201c, 201d, 201e, and 201f, of the advertisement management platform 201, the modules 206a, 206b, 206c, 206d, 206e, etc., of the mobile wallet application 206 on the consumer device 205, and the modules 1201a, 1201b, 1201c, 1201d, 1201e, etc., of the transaction management server 1201. The tasks performed by the operating system comprise assigning memory to the modules, for example, 201a, 201b, 201c, 201d, 201e, and 201f of the advertisement management platform 201, the modules 206a 206b, 206c, 206d, 206e, etc., of the mobile wallet application 206 on the consumer device 205, and the modules 1201a, 1201b, 1201c, 1201d, 1201e, etc., of the transaction management server 1201, moving data between the memory unit 1302 and disk units, and handling input/output operations. The operating system performs the tasks on request by the operations and after performing the tasks, the operating system transfers the execution control back to the processor 1301. The processor 1301 continues the execution to obtain one or more outputs. The outputs of the execution of the modules, for example, 201a, 201b, 201c, 201d, 201e, and 201f of the advertisement management platform 201 and the modules 1201a, 1201b, 1201c, 1201d, 1201e, etc., of the transaction management server 1201 respectively are displayed, for example, to the administrators of the advertisement management platform 201 and the transaction management server 1201 respectively. The outputs of the execution of the modules, for example, 206a 206b, 206c, 206d, 206e, etc., of the mobile wallet application 206 are displayed, for example, to the consumer using the consumer device 205.

Disclosed herein are also a first computer program product and a second computer program product, with the first computer program product and the second computer program product comprising a non-transitory computer readable storage medium that stores computer program codes comprising instructions executable by at least one processor 1301. As used herein, the term “non-transitory computer readable storage medium” refers to all computer readable media, for example, non-volatile media such as optical disks or magnetic disks, volatile media such as a register memory, processor cache, etc., and transmission media such as wires that constitute a system bus coupled to the processor 1301, except for a transitory, propagating signal.

The first computer program product disclosed herein comprises one or more computer program codes for managing advertisements, electronic commerce, and consumer services. For example, the first computer program product disclosed herein comprises a first computer program code for registering one or more of the consumers with the advertisement distribution service by creating a consumer profile for each of those consumers; a second computer program code for targeting advertisements to the registered consumers based on the dynamic behavioral data of the registered consumers through one or more of multiple media and communication channels; a third computer program code for engaging the registered consumers with the targeted advertisements based on the advertisement engagement plan of the advertisement distribution service; and a fourth computer program code for providing the registered consumers with one or more incentives, for example, coupons and electronic currency when the response to one or more of the predetermined number of targeted advertisements confirms consumption of the targeted advertisements. The first computer program product disclosed herein further comprises, for example, a fifth computer program code for enabling exchange of the coupons and the electronic currency stored in the mobile wallet application 206 among the registered consumers and for retail transactions using the electronic commerce management server 202.

The second computer program product disclosed herein comprises one or more computer program codes for managing electronic currency of a consumer. The second computer program product disclosed herein comprises a first computer program code for providing the mobile wallet application 206 on a consumer device 205 of a consumer, where the mobile wallet application 206 communicates with the transaction management server 1201 via the network 204; a second computer program code for receiving and storing incentives obtained by the consumer for engaging in one or more commercial activities by the mobile wallet application 206; a third computer program code for converting the incentives to the electronic currency and storing the electronic currency in the mobile wallet application 206; a fourth computer program code for generating one or more electronic monetary objects using the electronic currency by the mobile wallet application 206, in communication with the transaction management server 1201 via the network 204; and a fifth computer program code for conducting one or more transactions using the electronic currency and/or the generated electronic monetary objects by the mobile wallet application 206, in communication with the transaction management server 1201 via the network 204.

The first computer program product and the second computer program product disclosed herein further comprise additional computer program codes for performing additional steps that may be required and contemplated for managing advertisements, electronic commerce, consumer services, and the electronic currency of the consumer.

The computer program codes comprising the computer executable instructions for managing advertisements, electronic commerce, consumer services, and electronic currency are embodied on the non-transitory computer readable storage medium. The processor 1301 of the computer system 1300 retrieves these computer executable instructions and executes them. When the processor 1301 executes the computer executable instructions, the computer executable instructions cause the processor 1301 to perform the method steps for managing advertisements, electronic commerce, consumer services, and electronic currency. In an embodiment, a single piece of computer program code comprising computer executable instructions performs one or more steps of the computer implemented method disclosed herein for managing advertisements, electronic commerce, consumer services, and electronic currency.

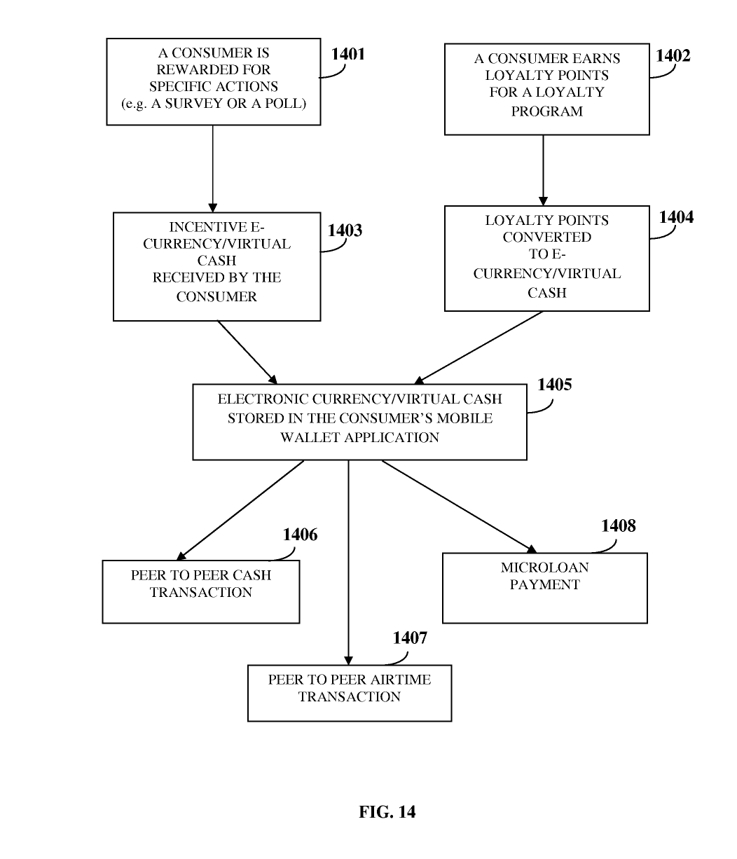

FIG. 14 exemplarily illustrates a flow chart depicting the flow of the electronic currency into multiple transactions according to the computer implemented method and system 1200, exemplarily illustrated in FIG. 12, disclosed herein. The consumer may earn electronic currency or virtual cash in several different ways, for example, by participating in surveys or polls and loyalty programs. The consumer is rewarded 1401 incentives for performing specific actions for example, completing the surveys or polls, which in an embodiment, is received 1403 by the consumer as electronic currency. The consumer earns 1402 loyalty points for a loyalty program and can convert 1404 the loyalty points into an equivalent amount of electronic currency or virtual cash. The electronic currency or virtual cash received by the consumer is stored 1405, for example, in the mobile wallet application 206 on the consumer device 205 of the consumer. The electronic currency may be utilized for purposes such as retail transactions, peer-to-peer cash transactions 1406 via ATMs, peer-to-peer airtime transactions 1407, micro-loan payments 1408 and repayment, etc.

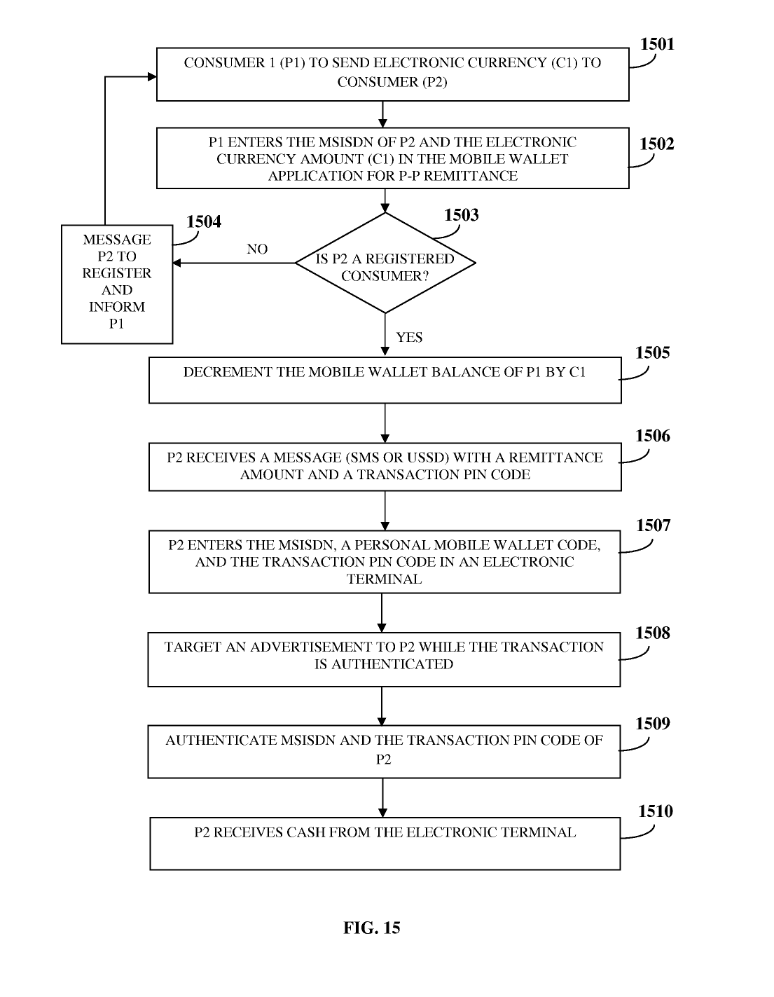

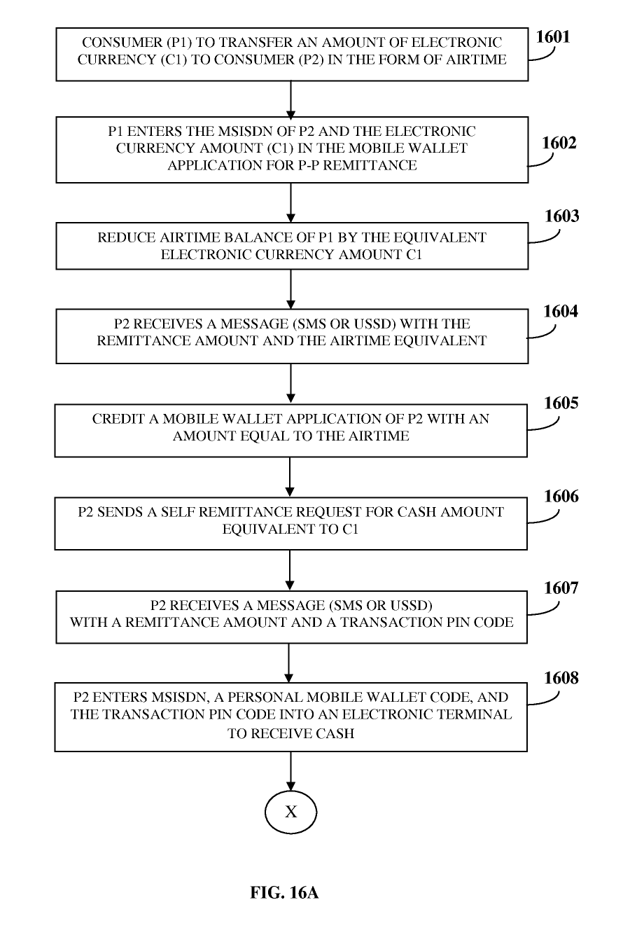

FIG. 15 exemplarily illustrates a flow chart comprising the steps for a peer-to-peer cash remittance of electronic currency using the mobile wallet application 206 according to the computer implemented method and system 1200, exemplarily illustrated in FIG. 12, disclosed herein. A consumer P1 wishes to transfer or send 1501 electronic currency C1 to another consumer P2. Consumer P1 enters 1502 the mobile subscriber integrated services digital network number (MSISDN) of P2 and the electronic currency amount C1 into the mobile wallet application 206 via the GUI 206f for initiating the peer-to-peer (P-P) remittance functionality. The mobile wallet application 206 sends the request for the remittance to the transaction management server 1201 via the network 204, which determines 1503 whether P2 is a registered consumer of the advertisement management platform 201. If consumer P2 is not a registered consumer, the transaction management server 1201 prompts 1504 consumer P2 with a message to register and informs consumer P1 accordingly. Consumer P1 may then proceed to send 1501 the electronic currency C1 to consumer P2. If consumer P2 is a registered consumer, the transaction management server 1201 acknowledges the remittance request and decrements 1505 the mobile wallet balance in the mobile wallet application 206 of consumer P1 by the amount C1 via the network 204. Consumer P2 then receives 1506 a message, for example, a short message service (SMS) message or an unstructured supplementary service data (USSD) message with the remittance amount and a transaction PIN code from the transaction management server 1201 via the network 204. Consumer P2 enters 1507 the MSISDN, a personal mobile wallet code, and the transaction PIN code into an electronic terminal, for example, an ATM or a retail POS terminal. The electronic terminal authenticates the transaction by establishing a communication with the transaction management server 1201 via the network 204. The transaction management server 1201 transmits a message to the advertisement management platform 201 via the network 204, indicating that the transaction for consumer P2 is ongoing. During this wait period for authentication, the advertisement management platform 201, in communication with the electronic terminal via the network 204, targets 1508 an advertisement for consumer P2 to view. When the MSISDN and the transaction PIN code of consumer P2 are authenticated 1509 by the electronic terminal, consumer P2 receives 1510 cash from the electronic terminal.

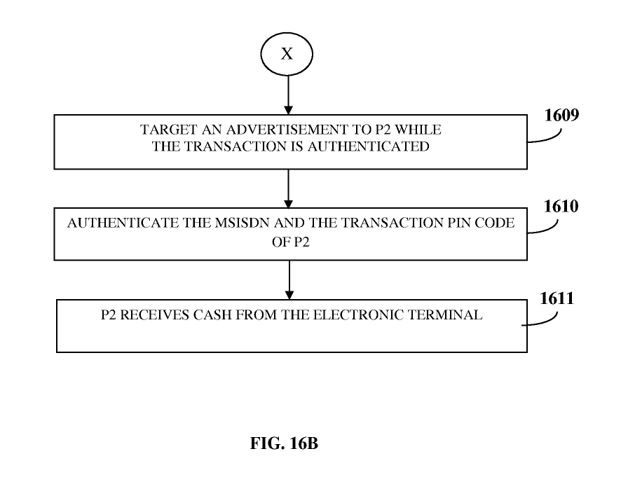

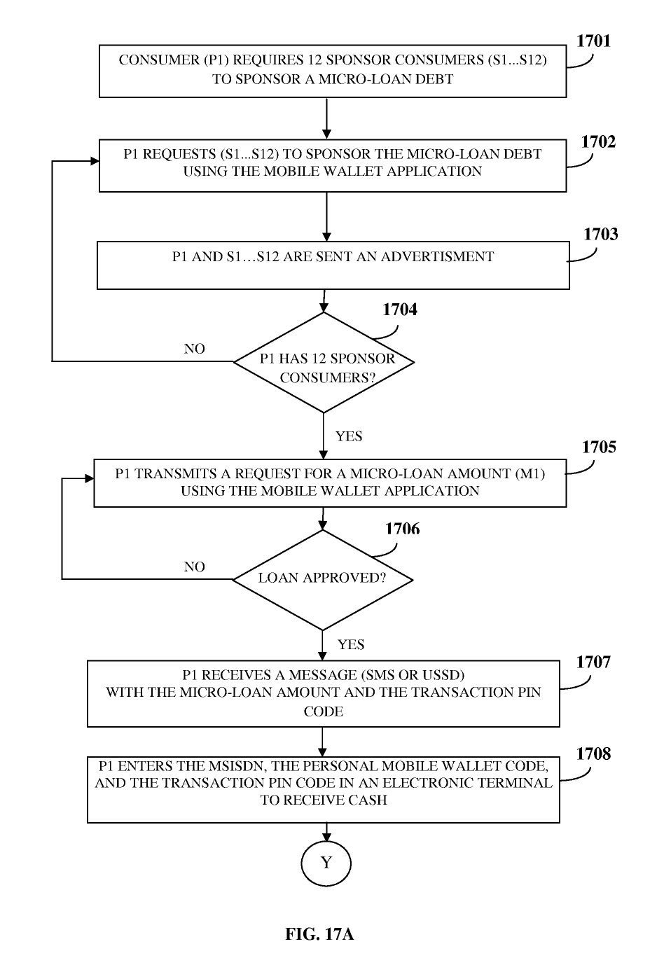

FIGS. 16A-16B exemplarily illustrate a flow chart comprising the steps for a peer-to-peer airtime remittance using the mobile wallet application 206 according to the computer implemented method and system 1200, exemplarily illustrated in FIG. 12, disclosed herein. Consumer P1 wishes to transfer 1601 an amount of electronic currency C1 in the form of airtime to another consumer P2. Consumer P1 enters 1602 the mobile subscriber integrated services digital network number (MSISDN) of consumer P2 and the amount of electronic currency C1 equivalent to the required airtime, into the mobile wallet application 206 via the GUI 206f for initiating the peer-to-peer (P-P) remittance functionality. The mobile wallet application 206 sends the request for the remittance to the transaction management server 1201 via the network 204, which acknowledges the remittance request and reduces 1603 an airtime balance in the mobile wallet application 206 of consumer P1 equivalent to the electronic currency amount C1. Consumer P2 then receives 1604 a message, for example, an SMS message or a USSD message with the remittance amount and the transferred airtime equivalent from the transaction management server 1201 via the network 204. In an embodiment, the mobile wallet application 206 of consumer P2 is credited 1605 with the electronic currency amount equivalent to the transferred airtime. Using the mobile wallet application 206 of consumer P2, consumer P2 sends 1606 a self remittance request for a cash amount equivalent to C1 to the transaction management server 1201 via the network 204. Consumer P2 receives 1607 another message, for example, an SMS message or a USSD message with the remittance amount and a transaction PIN code from the transaction management server 1201 via the network 204. Consumer P2 enters 1608 the MSISDN, personal mobile wallet code, and the transaction PIN code into an electronic terminal, for example, an ATM to receive cash. The electronic terminal authenticates the transaction by establishing a communication with the transaction management server 1201 via the network 204 and verifying the transaction details with the transaction management server 1201. The transaction management server 1201 transmits a message to the advertisement management platform 201 via the network 204 indicating that the transaction for consumer P2 is ongoing. During this wait period for authentication, the advertisement management platform 201, in communication with the electronic terminal via the network 204, targets 1609 an advertisement for consumer P2 to view. When the MSISDN and the PIN code of consumer P2 are authenticated 1610 by the electronic terminal, consumer P2 receives 1611 cash from the electronic terminal.

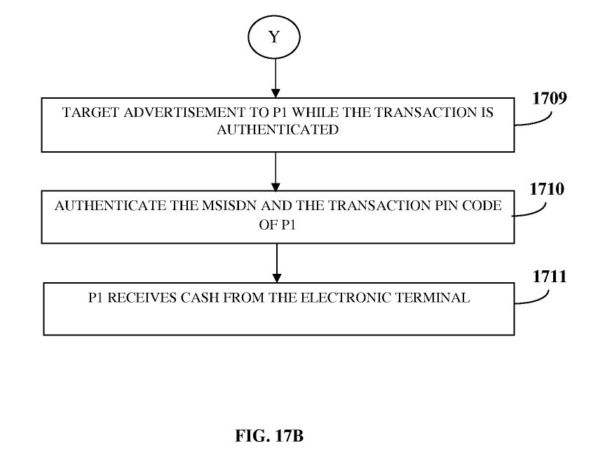

FIGS. 17A-17B exemplarily illustrate a flow chart comprising the steps for a micro-loan transaction according to the computer implemented method and system 1200, exemplarily illustrated in FIG. 12, disclosed herein. A consumer P1 requiring a loan sends a request for a micro-loan using the mobile wallet application 206 to the transaction management server 1201 via the network 204. For approving a micro-loan, the transaction management server 1201 requires 1701, for example, twelve other registered sponsor consumers (S1 . . . S12) to sponsor the micro-loan debt for consumer P1. Accordingly, consumer P1 requests 1702 twelve other registered sponsor consumers (S1 . . . S12) to sponsor the micro-loan debt, using the consumer P1's mobile wallet application 206. The requests are forwarded to the sponsor consumers via the transaction management server 1201 over the network 204. The transaction management server 1201 notifies the advertisement management platform 201 that a transaction has been initiated among a set of consumers. Along with the request for sponsoring the micro-loan debt, the advertisement management platform sends 1703 each of the twelve registered sponsor consumers an advertisement. The transaction management server 1201 checks 1704 whether consumer P1 has obtained twelve sponsor consumers to sponsor the micro-loan debt. If consumer P1 has not obtained twelve sponsor consumers, consumer P1 proceeds to request 1702 other registered sponsor consumers (S1 . . . S12) to sponsor the micro-loan debt. Once consumer P1 has obtained twelve sponsor consumers to sponsor the micro-loan debt, consumer P1 transmits a request 1705 for the micro-loan amount M1 to a predetermined number of second consumers using the mobile wallet application 206 via the transaction management server 1201 over the network 204. The transaction management server 1201 checks 1706 whether the micro-loan request has been approved by the second consumers. If the micro-loan request has not been approved by the second consumers, the transaction management server 1201 notifies consumer P1 to allow consumer P1 to transmit 1705 a request for the micro-loan amount M1 to other second consumers. If the micro-loan request has been approved by the second consumers, the transaction management server 1201 notifies consumer P1 by sending a message to the mobile wallet application 206 of consumer P1. Consumer P1 receives 1707 the message, for example, an SMS message or a USSD message with the micro-loan amount and a transaction PIN code. Consumer P1 enters 1708 the MSISDN, the personal mobile wallet code, and the transaction PIN code into an electronic terminal, for example, an ATM to receive cash. The electronic terminal authenticates the transaction by establishing a communication with the transaction management server 1201 via the network 204 and verifying the transaction details with the transaction management server 1201. The transaction management server 1201 transmits a message to the advertisement management platform 201 via the network 204, indicating that the transaction for consumer P2 is ongoing. During this wait period for authentication, the advertisement management platform 201 in communication with the electronic terminal via the network 204, targets 1709 an advertisement for consumer P1 to view. When the MSISDN and the PIN code of consumer P1 are authenticated 1710 by the electronic terminal, consumer P1 receives 1711 cash from the electronic terminal.

Consider an example where a registered consumer has a pre-paid account with a mobile phone service. The value of the pre-paid account is stored as cash in the mobile wallet application 206 of the consumer. The consumer purchases airtime credit for $10. Considering that the mobile phone service charges 10 cents per minute, the consumer obtains 100 minutes of airtime for the purchase of airtime credit worth $10. For example, when the consumer purchases $10 worth of airtime credit, the remittance message sent and displayed to the consumer on the GUI 206f is “You have received 100 minutes airtime”. In an embodiment, the airtime credit is converted to equivalent electronic currency worth $10 and stored in the mobile wallet application 206 of the consumer. In an embodiment, the airtime credit is automatically stored in the form of virtual cash. Subsequently, the consumer may desire to utilize or access the virtual cash stored in the mobile wallet application 206 for making purchases other than airtime credit. The mobile wallet application 206 enables the consumer to remit the stored virtual cash to make purchases at retail establishments.

Consider another example where a registered consumer acquires a coupon from the advertisement management platform 201 for confirming consumption of one or more advertisements delivered to the consumer. The coupon is stored in the mobile wallet application 206 of the consumer. Subsequently, when the consumer redeems that coupon at a retail establishment, the coupon is removed from the mobile wallet application 206, since the coupon has been redeemed to make a purchase or to obtain a discount. The value of the coupon may either be deducted from the check out total at the retailer cash register, or alternatively may be credited back to the mobile wallet application 206 in the form of additional airtime credit. In another example, the equivalent airtime credit is stored as virtual cash in the mobile wallet application 206 and may be transferred to a peer or another registered consumer via the transaction management server 1201 over the network 204. The actual transfer from one consumer to another consumer may be a total of airtime minutes or actual cash through an electronic terminal, for example, an ATM. In the case of airtime minutes being transferred, once the transfer is complete, the airtime minutes may be converted back to equivalent cash based on the cost per minute of airtime.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor, or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes the main memory. Volatile media comprise, for example, a register memory, processor cache, a random access memory (RAM), etc. Transmission media comprise, for example, coaxial cables, copper wire and fiber optics, including the wires that constitute a system bus coupled to a processor. Common forms of computer readable media comprise, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, and digital signal processors or like devices. Typically, a processor receives instructions from a memory or like device, and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Thus, embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as an object code. The computer program product disclosed herein comprises computer executable instructions embodied in a non-transitory computer readable storage medium, wherein the computer program product comprises computer program codes for implementing the processes of various embodiments.

Where databases are described such as the data warehouse 203, and the transaction information database 1201e, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment including a computer that is in communication with one or more devices via a communication network. The computer may communicate with the devices directly or indirectly, via a wired medium or a wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, IBM® processors, etc., that are adapted to communicate with the computer. Any number and type of machines may be in communication with the computer.

The foregoing examples have been provided merely for the purpose of explanation and are in no way to be construed as limiting of the invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A computer implemented method for managing electronic currency of a consumer, comprising:
providing a mobile wallet application executable by at least one processor on a consumer device of said consumer;
providing a transaction management server, in communication with said mobile wallet application via a network, said transaction management server comprising at least one processor configured to manage said electronic currency of said consumer;
receiving and storing incentives obtained by said consumer for engaging in one or more commercial activities, by said mobile wallet application;
converting said incentives to said electronic currency and storing said electronic currency in said mobile wallet application;
generating one or more electronic monetary objects using said electronic currency by said mobile wallet application, in communication with said transaction management server via said network; and
conducting one or more transactions using one of said electronic currency and said generated one or more electronic monetary objects by said mobile wallet application, in communication with said transaction management server via said network.

2. The computer implemented method of claim 1, wherein said generated one or more electronic monetary objects comprise one or more of cash and airtime credit.

3. The computer implemented method of claim 1, wherein said one or more commercial activities engaged by said consumer comprise one or more of purchasing a product and/or a service, responding to a targeted advertisement, completing a survey, completing a poll, opting in for a loyalty program, and submitting a review.

4. The computer implemented method of claim 1, wherein said conduction of said one or more transactions comprises transferring said electronic currency from said mobile wallet application of a first said consumer to a second said consumer.

5. The computer implemented method of claim 1, wherein said conduction of said one or more transactions comprises transferring said generated one or more electronic monetary objects from said mobile wallet application of a first said consumer to a second said consumer.

6. The computer implemented method of claim 1, wherein said conduction of said one or more transactions comprises engaging in a loan transaction with one or more second consumers by a first said consumer via said mobile wallet application using said electronic currency configured as a micro-loan.

7. The computer implemented method of claim 1, further comprising tracking information on said one or more transactions by said transaction management server and storing said tracked information in a data warehouse.

8. The computer implemented method of claim 1, further comprising targeting advertisements to said consumer by one or more of a plurality of advertising entities on receiving an indication from said transaction management server, during said conduction of said one or more transactions by said mobile wallet application.

9. The computer implemented method of claim 1, further comprising generating a transaction code by said transaction management server for each of said one or more transactions and transmitting said generated transaction code to said mobile wallet application on said consumer device of said consumer via said network.

10. A computer implemented method for managing electronic currency of a consumer, comprising:
providing a mobile wallet application executable by at least one processor on a consumer device of said consumer;
providing a transaction management server, in communication with said mobile wallet application via a network, said transaction management server comprising at least one processor configured to manage said electronic currency of said consumer;
receiving and storing incentives obtained by said consumer for engaging in one or more commercial activities, by said mobile wallet application;
converting said incentives to said electronic currency and storing said electronic currency in said mobile wallet application;
acquiring transaction information from a first said consumer by said mobile wallet application of said first said consumer via a graphical user interface of said mobile wallet application, wherein said transaction information comprises identification information of a second said consumer and an amount of said electronic currency to be transferred to said second said consumer;
transmitting said acquired transaction information to said transaction management server by said mobile wallet application of said first said consumer via said network;
decrementing said amount of said electronic currency from said mobile wallet application of said first said consumer and transmitting said amount of said electronic currency to said mobile wallet application of said second said consumer by said transaction management server via said network; and
receiving said transmitted amount of said electronic currency by said mobile wallet application of said second said consumer and redeeming said received amount of said electronic currency for conducting one or more transactions.

11. A computer implemented method for managing electronic currency of a consumer, comprising:
providing a mobile wallet application executable by at least one processor on a consumer device of said consumer;
providing a transaction management server, in communication with said mobile wallet application via a network, said transaction management server comprising at least one processor configured to manage said electronic currency of said consumer;
receiving and storing incentives obtained by said consumer for engaging in one or more commercial activities, by said mobile wallet application;
converting said incentives to said electronic currency and storing said electronic currency in said mobile wallet application;
generating airtime credit using said electronic currency by said mobile wallet application, in communication with said transaction management server via said network;
acquiring transaction information from a first said consumer by said mobile wallet application of said first said consumer via a graphical user interface of said mobile wallet application, wherein said transaction information comprises identification information of a second said consumer and an amount of said airtime credit to be transferred to said second said consumer;
transmitting said acquired transaction information to said transaction management server by said mobile wallet application of said first said consumer via said network;
decrementing said amount of said airtime credit from said mobile wallet application of said first said consumer and transmitting said amount of said airtime credit to said mobile wallet application of said second said consumer by said transaction management server via said network; and
receiving said transmitted amount of said airtime credit by said mobile wallet application of said second said consumer and redeeming said received amount of said airtime credit for mobile communication services.

12. The computer implemented method of claim 11, further comprising converting said received amount of said airtime credit to equivalent cash by said mobile wallet application of said second said consumer for conducting one or more transactions.

13. A computer implemented method for managing electronic currency of a consumer, comprising:
providing a mobile wallet application executable by at least one processor on a consumer device of said consumer;
providing a transaction management server, in communication with said mobile wallet application via a network, said transaction management server comprising at least one processor configured to manage said electronic currency of said consumer;
receiving and storing incentives obtained by said consumer for engaging in one or more commercial activities, by said mobile wallet application;
converting said incentives to said electronic currency and storing said electronic currency in said mobile wallet application;
generating micro-loans using said electronic currency by said mobile wallet application, in communication with said transaction management server via said network;
receiving a request for one or more of said generated micro-loans from a second said consumer by said mobile wallet application of said first said consumer via said transaction management server over said network;
transmitting said one or more of said generated micro-loans to said mobile wallet application of said second said consumer via said transaction management server over said network, after said first said consumer approves said request; and
decrementing said one or more of said generated micro-loans from said mobile wallet application of said first said consumer by said transaction management server via said network.

14. A computer implemented method for managing electronic currency of a consumer, comprising:
providing a mobile wallet application executable by at least one processor on a consumer device of said consumer;
providing a transaction management server, in communication with said mobile wallet application via said network, said transaction management server comprising at least one processor configured to manage said electronic currency of said consumer;
transmitting a request for a micro-loan by said mobile wallet application of a first said consumer to a predetermined number of second consumers via said transaction management server over said network;
receiving said micro-loan from said predetermined number of said second consumers by said mobile wallet application of said first said consumer via said transaction management server over said network, on approval of said request by said second consumers; and
storing said micro-loan as said electronic currency in said mobile wallet application of said first said consumer for conducting one or more transactions.

15. The computer implemented method of claim 14, wherein said transaction management server defines a predetermined number of sponsor consumers required by said first said consumer for sponsoring a debt of said micro-loan for said first said consumer.

16. The computer implemented method of claim 15, further comprising transmitting a sponsor request to said predetermined number of said sponsor consumers by said mobile wallet application of said first said consumer via said transaction management server over said network, wherein said mobile wallet application of said first said consumer receives said micro-loan from said predetermined number of said second consumers on acceptance of said sponsor request by said predetermined number of said sponsor consumers who agree to sponsor said debt of said micro-loan for said first said consumer.

17. A computer implemented system for managing electronic currency of a consumer, comprising:
a transaction management server in communication with a mobile wallet application via a network, said transaction management server comprising at least one processor configured to manage said electronic currency of said consumer; and
said mobile wallet application executable by at least one processor configured to execute modules of said mobile wallet application on a consumer device of said consumer, said modules of said mobile wallet application comprising:
a storage module that receives and stores incentives obtained by said consumer for engaging in one or more commercial activities;
a conversion module that converts said incentives to said electronic currency and stores said electronic currency in said storage module;
a monetary object generation module that generates one or more electronic monetary objects using said electronic currency, in communication with said transaction management server via said network; and
a transaction module that conducts one or more transactions using one of said electronic currency and said generated one or more electronic monetary objects, in communication with said transaction management server via said network.

18. The computer implemented system of claim 17, wherein said transaction module of said mobile wallet application of a first said consumer, in communication with said transaction management server via said network, transfers said electronic currency to a second said consumer during said conduction of said one or more transactions.

19. The computer implemented system of claim 17, wherein said transaction module of said mobile wallet application of a first said consumer, in communication with said transaction management server via said network, transfers said generated one or more electronic monetary objects to a second said consumer during said conduction of said one or more transactions.

20. The computer implemented system of claim 17, wherein said modules of said mobile wallet application further comprise a micro-loan management module, in communication with said transaction module and said transaction management server via said network, wherein said micro-loan management module engages a first said consumer in a loan transaction with one or more second consumers using said electronic currency configured as a micro-loan.

21. The computer implemented system of claim 20, wherein said micro-loan management module of said mobile wallet application of said first said consumer, in communication with said transaction management server via said network, performs:
generating micro-loans using said electronic currency;
receiving a request for one or more of said generated micro-loans from each of said one or more second consumers; and
transmitting said one or more of said generated micro-loans to said mobile wallet application of said each of said one or more second consumers via said network, after said first said consumer approves said request.

22. The computer implemented system of claim 20, wherein said micro-loan management module of said mobile wallet application of said first said consumer, in communication with said transaction management server via said network, performs:
transmitting a request for a micro-loan to a predetermined number of said one or more second consumers;
receiving said micro-loan from said predetermined number of said one or more second consumers, on approval of said request by said one or more second consumers; and
storing said micro-loan as said electronic currency in said storage module of said mobile wallet application of said first said consumer for conducting one or more transactions.

23. The computer implemented system of claim 22, wherein said micro-loan management module of said mobile wallet application of said first said consumer transmits a sponsor request to a predetermined number of sponsor consumers via said transaction management server over said network, wherein said micro-loan management module of said mobile wallet application of said first said consumer receives said micro-loan from said predetermined number of said one or more second consumers on acceptance of said sponsor request by said predetermined number of said sponsor consumers who agree to sponsor a debt of said micro-loan for said first said consumer, wherein said transaction management server defines said predetermined number of said sponsor consumers required by said first said consumer for sponsoring said debt of said micro-loan for said first said consumer.

24. The computer implemented system of claim 17, wherein said transaction module of said mobile wallet application of a first said consumer performs:
acquiring transaction information from said first said consumer via a graphical user interface of said mobile wallet application, wherein said transaction information comprises identification information of a second said consumer and an amount of one of said electronic currency, one or more of said generated one or more monetary objects, and a combination thereof, to be transferred to said second said consumer; and
transmitting said acquired transaction information to said transaction management server via said network.

25. The computer implemented system of claim 24, wherein said transaction module of said mobile wallet application of said second said consumer receives said amount of said one of said electronic currency, said one or more of said generated one or more monetary objects, and said combination thereof, and redeems said received amount of said one of said electronic currency, said one or more of said generated one or more monetary objects, and said combination thereof, for conducting said one or more transactions.

26. The computer implemented system of claim 25, wherein said conversion module of said mobile wallet application of said second said consumer converts said received amount of said one of said electronic currency, said one or more of said generated one or more monetary objects, and said combination thereof, to equivalent cash for said conduction of said one or more transactions.

27. The computer implemented system of claim 17, wherein said transaction management server comprises a currency management module executable by said at least one processor of said transaction management server, wherein said currency management module decrements an amount of one of said electronic currency, said one or more of said generated one or more monetary objects, and a combination thereof, from said mobile wallet application of a first said consumer via said network and transmits said amount of said one of said electronic currency, said one or more of said generated one or more monetary objects, and said combination thereof, to said mobile wallet application of a second said consumer via said network, based on transaction information acquired from said first said consumer.

28. The computer implemented system of claim 17, wherein said transaction management server further comprises a tracking module executable by said at least one processor of said transaction management server, wherein said tracking module tracks information on said one or more transactions and stores said tracked information in a data warehouse.

29. The computer implemented system of claim 17, wherein said transaction management server further comprises a transaction code generation module executable by said at least one processor of said transaction management server, wherein said transaction code generation module generates a transaction code for each of said one or more transactions and transmits said generated transaction code to said mobile wallet application on said consumer device of said consumer via said network.

30. A computer program product comprising a non-transitory computer readable storage medium, said non-transitory computer readable storage medium storing computer program codes that comprise instructions executable by at least one processor, said computer program codes comprising:
a first computer program code for providing a mobile wallet application on a consumer device of a consumer, wherein said mobile wallet application is in communication with a transaction management server via a network;
a second computer program code for receiving and storing incentives obtained by said consumer for engaging in one or more commercial activities, by said mobile wallet application;
a third computer program code for converting said incentives to said electronic currency and storing said electronic currency in said mobile wallet application;
a fourth computer program code for generating one or more electronic monetary objects using said electronic currency by said mobile wallet application, in communication with said transaction management server via said network; and
a fifth computer program code for conducting one or more transactions using one of said electronic currency and said generated one or more electronic monetary objects by mobile wallet application, in communication with said transaction management server via said network.
